(19) United States
(12) Patent Application Publication
(10) Pub. No.: US 2026/0290378 A1
(43) Pub. Date: Sep. 24, 2026

(54) SYSTEM

(71) Applicant: SoftBank Group Corp., Tokyo (JP)

(72) Inventor: Yumiko WATANABE, Tokyo (JP)

(73) Assignee: SoftBank Group Corp., Tokyo (JP)

(21) Appl. No.: 19/562,961

(22) Filed: Mar. 11, 2026

(30) Foreign Application Priority Data
Mar. 19, 2025 (JP) 2025-045049

(51) Int. Cl. G10L 25/63; G10L 15/16

(52) U.S. Cl. CPC G10L 25/63; G10L 15/16

(57) ABSTRACT

A system includes a processor that is configured to receive an utterance of a user through an input device, analyze the received utterance by using a natural language processing technique, generate a prompt for instructing a generative AI model to generate encouragement or advice based on a result of the analysis, and input the generated prompt to the generative AI model to cause the generative AI model to generate the encouragement or the advice.

### CROSS-REFERENCE TO RELATED APPLICATION

This application is based on and claims priority under 35 USC 119 from Japanese Patent Application No. 2025-045049 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative AI models have been increasingly used to provide conversational support, such as encouragement and advice, to users who disclose worries, stress, or daily concerns. However, conventional systems typically generate responses by directly providing the user's utterance to a generative AI model or by using simple templates, without explicitly structuring or controlling the instructions given to the generative AI model. As a result, the system may generate responses that are unfocused, overly generic, or inconsistent in tone and content. In addition, conventional systems often fail to take into sufficient account the emotional state of the user, such that the generated encouragement or advice may not appropriately match the user's current feelings or psychological situation. This mismatch can lead to a reduction in the perceived reliability, empathy, and usefulness of the system. Therefore, there is a need for a technique that enables the system to accurately analyze a user's utterance, to estimate the user's emotional state, and to generate structured prompts for a generative AI model so that the generated encouragement or advice is optimized in view of the user's emotional state and communication context.

### SUMMARY

In order to solve the above-described problems, according to one aspect of the present invention, there is provided a system comprising a processor, wherein the processor is configured to receive an utterance of a user through an input device, analyze the received utterance by using a natural language processing technique, generate a prompt for instructing a generative AI model to generate encouragement or advice based on a result of the analysis, and input the generated prompt to the generative AI model to cause the generative AI model to generate the encouragement or the advice. The processor is further configured to estimate an emotional state of the user based on the utterance of the user, and to generate, as the prompt for the generative AI model, a prompt that reflects the estimated emotional state. Moreover, the processor is configured to adjust the prompt to be input to the generative AI model in accordance with the emotional state of the user and to generate a prompt for instructing optimization of content of the encouragement or the advice. By explicitly generating and adjusting a prompt that incorporates both linguistic analysis of the user's utterance and the estimated emotional state, the system can control the generative AI model so that the model outputs encouragement or advice that is more tailored, empathetic, and context-appropriate for the user.

The term “processor” refers to one or more hardware computing elements, such as a central processing unit, microcontroller, or dedicated processing circuitry, configured to execute instructions and perform the functions described in the claims.

The term “system” refers to an arrangement including at least the processor and any associated components, devices, or modules that cooperate to perform the functions described in the claims.

The term “user” refers to a person who interacts with the system by providing utterances and receiving encouragement or advice generated by the system.

The term “utterance” refers to information expressed by the user in natural language, including spoken speech captured through an input device and/or text input entered via a keyboard or similar interface.

The term “input device” refers to any device or interface that receives the user's utterance, such as a microphone, a keyboard, a touch panel, or a graphical user interface for text input.

The term “natural language processing technique” refers to a computational technique for analyzing natural language, including at least one of morphological analysis, syntactic analysis, semantic analysis, tokenization, part-of-speech tagging, or similar linguistic processing.

The term “prompt” refers to a structured input instruction, including text or data, that is provided to the generative AI model to control or guide generation of output such as encouragement or advice.

The term “generative AI model” refers to a machine learning model configured to generate natural language text or similar content in response to an input prompt, based on patterns learned from training data.

The term “encouragement” refers to a generated message that aims to support, comfort, or positively motivate the user in relation to the user's situation or feelings.

The term “advice” refers to a generated message that aims to suggest actions, viewpoints, or strategies to the user in response to the user's situation or concerns.

The term “emotional state” refers to a psychological state of the user, such as sadness, worry, anxiety, anger, relief, or neutrality, as estimated based on the user's utterance.

The term “estimate” refers to a process of inferring or determining a value, state, or category, such as the emotional state of the user, based on analysis of the utterance and optionally other data.

The term “reflects the estimated emotional state” refers to including, in the prompt, information or instructions that are determined based on the estimated emotional state so that the generative AI model can generate output aligned with that emotional state.

The term “adjust the prompt” refers to modifying, supplementing, or selecting the content, structure, or parameters of the prompt in accordance with at least the estimated emotional state of the user.

The term “optimization of content of the encouragement or the advice” refers to improving or tailoring the generated encouragement or advice so that it is more appropriate, empathetic, and useful for the user, in view of the user's utterance and emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

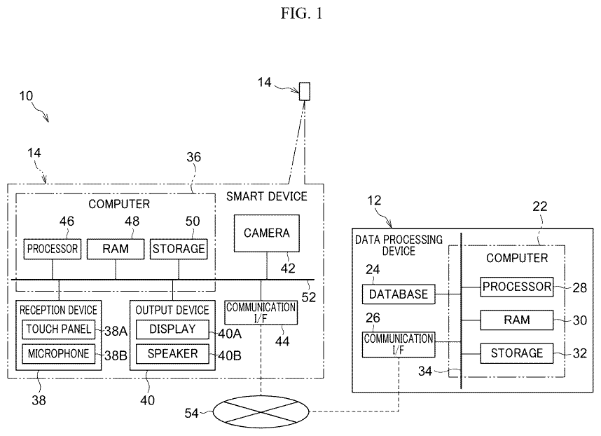

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

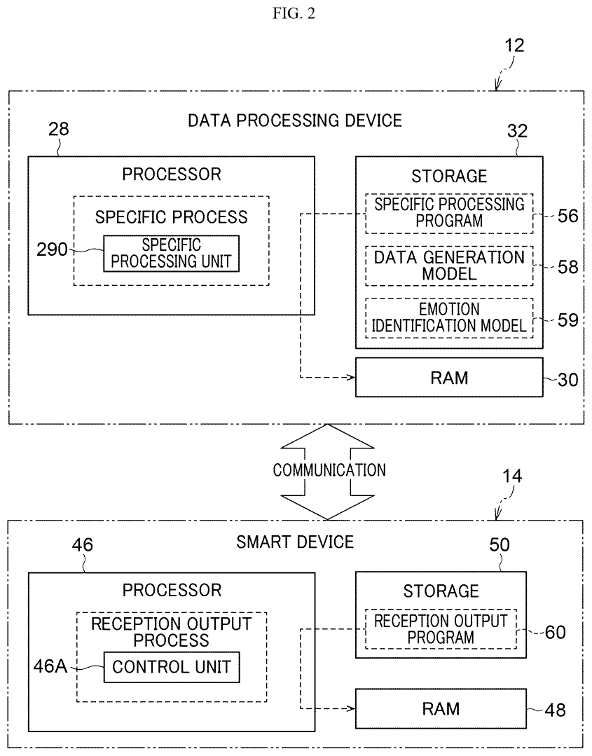

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that provide encouragement or advice based on user input typically apply generic response templates or invoke a generative AI model directly with minimal context. In many implementations, the server simply forwards a raw user utterance to a language model and returns the generated text to a client device. Such approaches present several technical problems in computer processing.

First, the server does not perform structured analysis of the user utterance to extract emotion, intent, and key phrase information. As a result, the prompt input to the generative AI model is not tailored to the user's emotional state or specific problem, which leads to responses that are either irrelevant or insufficiently supportive. From a computing standpoint, this causes inefficient utilization of computational resources of the generative AI model, because a large amount of inference processing is consumed to generate low-quality or off-target responses.

Second, conventional systems often treat the generative AI model as a black box without systematic control over the form and style of the prompt. Without prompt construction based on template information and analysis results, the system cannot dynamically adapt parameters such as style, length, and level of detail of the generated response. This lack of structured prompt optimization degrades the predictability and stability of the system's behavior, thereby complicating server-side control logic and error handling. It can also produce excessively long or complex outputs that increase bandwidth usage and processing latency on both the server and terminal devices.

Third, traditional systems commonly lack integrated server-side safety and appropriateness filtering of generated content. When the generative AI model returns harmful, inappropriate, or contextually unsafe text, the server may simply pass the text to the terminal. This not only raises user safety concerns but also creates a technical reliability problem: the server cannot guarantee quality constraints on outgoing content, making it difficult to enforce content policies or recover gracefully from problematic inference outputs.

Fourth, many systems do not define a coordinated control flow between server-side processing and terminal-side presentation of the generated responses. In particular, selection between text display and audio output is often performed in an ad hoc manner or implemented entirely on the client without a clear linkage to the server-side generation logic. This leads to redundant processing on the terminal, inconsistent user experience across devices, and suboptimal utilization of device-specific capabilities such as display resolution, audio output performance, and user accessibility preferences.

Accordingly, there is a need for a computer-implemented system and server-side processing technique that: (i) performs structured natural language processing to obtain emotion, intent, and key phrase analysis results; (ii) constructs a prompt sentence for a generative AI model using template information that dynamically reflects the user's emotional state and intent; (iii) performs safety and appropriateness filtering on the generated response; and (iv) coordinates with a terminal so that the response is presented in a form (text and/or audio) appropriate to user operations and device settings. Such a system should improve the technical functioning of the server and the interaction between the server, the generative AI model, and the terminal, by yielding more targeted, controllable, and resource-efficient generation and presentation of encouragement or advice.

The specific processing by the specific processing unit 290 of the data processing device 12 in Example 1 is realized by the following means.

The present invention provides a server comprising a processor configured to receive, from a terminal, digital information corresponding to a user utterance acquired via an input device, to apply a natural language processing technique to text information corresponding to the utterance so as to generate an analysis result including at least emotion information, intent information, and key phrase information, to construct, on the basis of the analysis result and in accordance with stored template information, a prompt sentence that reflects an emotional state and an intent of the user and that is configured as a prompt for input to a generative AI model, to input the prompt sentence to the generative AI model and cause the generative AI model to perform inference processing to generate a response sentence including encouragement or advice for the user, to execute filtering processing on the response sentence to determine at least one of safety and appropriateness of content of the response sentence and to modify the response sentence or control output permission of the response sentence based on a result of the filtering processing, and to transmit the response sentence to the terminal for presentation to the user as at least one of display output via a display device and audio output via a speech synthesis device. This enables the server to improve technical control over generative AI inference by dynamically optimizing prompt sentences according to structured analysis of the user utterance, enforcing safety and content constraints on generated responses, and coordinating with the terminal for modality-appropriate presentation, thereby enhancing computational efficiency, predictability, and reliability of computer-implemented encouragement and advice generation.

The term “system” refers to a combination of at least one server, at least one terminal, and associated hardware and software components configured to execute the processing described in the claims.

The term “processor” refers to a hardware processing unit, such as a central processing unit or a processing core, configured to execute instructions of a program to perform the functions recited in the claims.

The term “user” refers to a human individual who provides an utterance to the system and receives encouragement or advice generated by the system.

The term “utterance” refers to information expressing the user's message, including at least one of audio information obtained from spoken input and text information obtained from character input.

The term “input device” refers to hardware configured to acquire the user's utterance, including at least one of an audio input device and a character input device.

The term “terminal” refers to an information processing apparatus, such as a mobile terminal, a personal computer, or a similar device, configured to acquire the user's utterance via the input device, communicate with the server, and present a response sentence to the user.

The term “digital information” refers to data represented in an electronic format suitable for computer processing, including at least one of digitized audio data and text data corresponding to the user's utterance.

The term “text information” refers to a character string or sequence of symbols representing the content of the user's utterance in a form processable by natural language processing techniques.

The term “natural language processing technique” refers to a computer-implemented method for analyzing and processing text information expressed in a human language, including at least one of tokenization, syntactic analysis, semantic analysis, sentiment analysis, and classification.

The term “analysis result” refers to structured data generated by the natural language processing technique, including at least emotion information, intent information, and key phrase information extracted from the text information.

The term “emotion information” refers to data indicating an estimated emotional state of the user, such as sadness, anxiety, or encouragement need, derived from the content of the user's utterance.

The term “intent information” refers to data indicating an estimated purpose or objective of the user's utterance, such as seeking encouragement, requesting advice, or expressing concern.

The term “key phrase information” refers to data indicating words, phrases, or expressions extracted from the text information and representing main topics, issues, or contexts contained in the user's utterance.

The term “template information” refers to stored pattern information, including at least one of sentence patterns, placeholders, and control parameters, used to construct a prompt sentence by combining analysis results with predefined structures.

The term “prompt sentence” refers to a text sequence configured as an input instruction to the generative AI model, the text sequence incorporating at least one of the emotion information, the intent information, and the key phrase information so as to guide generation of the response sentence.

The term “generative AI model” refers to an artificial intelligence model, such as a large language model, configured to generate text data including the response sentence in accordance with the prompt sentence by performing inference processing.

The term “inference processing” refers to computation performed by the generative AI model using learned parameters to generate output data, including at least one of predicting token sequences and producing text corresponding to the prompt sentence.

The term “response sentence” refers to text data generated by the generative AI model in response to the prompt sentence, the text data including at least one of encouragement and advice intended for the user.

The term “filtering processing” refers to computer-implemented processing applied to the response sentence to determine at least one of safety and appropriateness of content, including at least one of detecting prohibited expressions, evaluating harmful content, and assessing compliance with predetermined rules.

The term “safety” refers to a property of the response sentence indicating that the content does not include harmful, dangerous, or otherwise prohibited expressions according to predetermined safety criteria.

The term “appropriateness” refers to a property of the response sentence indicating that the content conforms to predetermined guidelines regarding tone, relevance, and suitability for presentation to the user.

The term “output permission” refers to control information indicating whether the response sentence, as generated or modified, is allowed to be transmitted to the terminal and presented to the user.

The term “display device” refers to hardware configured to visually present text or images, such as a display panel, a monitor, or another visual output apparatus.

The term “speech synthesis device” refers to hardware and associated software configured to convert text into audible sound, including at least one of a speech synthesis engine and an audio output apparatus.

The term “display output” refers to presentation of the response sentence as visual information on the display device in a form perceivable by the user.

The term “audio output” refers to presentation of the response sentence as audible sound generated by the speech synthesis device in a form perceivable by the user.

The term “operation information” refers to data indicating user operations on the terminal, including at least one of button selections, touch inputs, voice commands, and configuration changes that influence how the response sentence is presented.

The term “setting information” refers to configuration data of the terminal, including at least one of user preferences, accessibility options, and device-specific parameters, that influence selection between display output and audio output.

In one embodiment, a server cooperates with at least one terminal to implement a system that generates encouragement or advice for a user on the basis of an utterance of the user. The server includes at least one processor, a memory storing programs and data structures, and a communication interface connected to a network. The terminal includes at least one processor, an input device, a display device, an audio output device, and a communication interface.

The terminal acquires the user's utterance via hardware input devices. The terminal uses a microphone as an audio input device when the user speaks, and uses a keyboard or touch-screen input framework as a character input device when the user types text. The terminal uses an operating system audio stack, such as an audio recording application programming interface of a mobile operating system, to sample the analog signal from the microphone into digital audio data with a defined sampling rate and bit depth. The terminal stores the sampled audio frames in a buffer in a memory device, and then encapsulates the buffer in a data structure that additionally contains metadata such as a user identifier, a language code, and a timestamp. The terminal transmits the data structure to the server by invoking an HTTPS client library running on the terminal processor.

The server receives the transmitted data structure through a web application stack. The server uses a web framework executing on the server processor and a transport layer security termination component to parse the incoming request and extract the digital audio data or text data. The server normalizes the data so that downstream modules receive audio in a standard sampling rate and format, and text encoded in a uniform character encoding. When the input is audio, the server uses an automatic speech recognition module implemented by a neural network model, such as an encoder-decoder architecture or a transformer-based acoustic-language model, to convert the digital audio data into text information. The server processor executes this automatic speech recognition by loading model parameters from the memory into a processing accelerator, such as a graphics processing unit, and performing matrix multiplications and non-linear activation operations on feature vectors derived from the audio waveform.

The server applies a natural language processing module to the text information. The server uses a tokenization module to segment the text into tokens, and uses a syntactic and semantic analysis module to compute part-of-speech tags, dependency relations, and semantic role labels. The server also applies an emotion classification model and an intent classification model. In one example, the server uses a transformer-based text encoder, such as a multi-layer self-attention network, that maps the sequence of tokens into contextual embedding vectors. The server feeds the contextual embedding vectors into classification layers, such as linear layers followed by softmax functions, to output probability distributions over a predefined set of emotion classes and intent classes. The server stores the outputs as emotion information and intent information in a structured analysis result object that also includes key phrase information.

The server extracts key phrase information by applying a key phrase extraction algorithm to the contextual embedding vectors and token features. In one embodiment, the server uses an attention-based scoring function to compute relevance scores for each token or token span, and then selects those spans whose scores exceed a threshold as key phrases. The server records the selected key phrases as string segments associated with positions in the original text.

The server stores the analysis result object in the memory as a data structure that includes fields such as emotion_label, emotion_score, intent_label, and key_phrases. The server uses template information stored in the memory to construct a prompt sentence for a generative AI model. The template information includes sentence patterns with placeholders and control parameters indicating a desired style, length, and level of detail of the prompt sentence. For example, the server stores a template of the form:

“The user feels {emotion} because {problem_description}. Provide empathetic encouragement and one or two practical, gentle suggestions. Use a supportive and non-judgmental tone.”

The server fills the placeholders by mapping the emotion_label to the {emotion} placeholder and by combining one or more key phrases with the intent_label to produce the {problem_description} placeholder. The server may, for instance, combine key phrases such as “work is not going well” and “feel really down” with the intent “seeking encouragement about work” to obtain a textual description “their work is not going well and they feel really down.” The server inserts this description into the template to construct a prompt sentence such as: “The user feels sad and discouraged because their work is not going well and they feel really down. As a supportive assistant, provide kind encouragement and two simple, practical suggestions to help them cope. Use a warm, empathetic, and non-judgmental tone.”

The server configures the constructed prompt sentence as an input to the generative AI model. The generative AI model is implemented as a trained neural network model, such as a large language model having a plurality of transformer layers. Each transformer layer includes at least one self-attention mechanism and at least one feed-forward network. The server stores model parameters, such as weight matrices and bias vectors, in a model storage region of the memory. The server loads part of these parameters into the processor cache and an attached accelerator device. The server executes inference processing by computing, for each layer, linear transformations of token embeddings, attention weight computations, application of activation functions, and normalization operations. The server uses a decoding algorithm, such as greedy decoding or beam search, to iteratively generate tokens of the response sentence conditioned on the prompt sentence.

The server provides additional control signals to the generative AI model by including control tokens or explicit instructions in the prompt sentence. The server can, for example, prepend phrases such as “Use short, clear sentences” or “Do not provide medical or legal advice” to the prompt sentence. By doing so, the server constrains the search space of the decoding algorithm and reduces the probability of generating undesired patterns. This results in a technical effect of reducing the number of generated tokens requiring filtering and thereby reducing inference time and communication bandwidth.

The server applies a filtering processing module to the response sentence generated by the generative AI model. The server uses one or more content analysis algorithms, such as rule-based pattern matching, toxicity scoring models, and classification models trained to detect policy-violating content. The server represents the response sentence as a token sequence, computes feature vectors using an encoder network or feature extraction function, and evaluates these feature vectors against thresholds or heuristic rules. When the server detects a violation, the server either modifies the response sentence by removing problematic segments or triggers regeneration by invoking the generative AI model with an adjusted prompt sentence that includes additional constraints, such as “Avoid discussing self-harm.” The server stores the filtered or regenerated response sentence as final response data for transmission.

The server transmits the response sentence to the terminal through the communication interface. The terminal receives the response sentence and uses its processor to determine a presentation mode. The terminal uses setting information indicating user preferences, such as a preference for audio playback for visually impaired users, or operation information, such as a user's selection of a “read aloud” button. Based on this information, the terminal either selects text display output, audio output, or a combination. The terminal renders the response sentence on a display device using a graphical user interface toolkit, and/or uses a speech synthesis engine to convert the text into an audio waveform. The terminal writes the audio waveform into an audio buffer and uses the operating system audio subsystem to drive loudspeakers or headphones.

The user receives the encouragement or advice as a visual or auditory output. The user may generate further utterances in response, and the terminal and server repeat the above operations in a continuous interaction. Through this repeated interaction, the server continuously refines prompt sentences in accordance with updated analysis results, thereby maintaining alignment of generated content with the user's emotional state.

The server improves computer technology in several ways. The server reduces unnecessary inference computation of the generative AI model by constructing prompt sentences that are constrained and precise, thus narrowing the distribution of possible outputs and reducing the average sequence length generated. Because the prompt sentence is generated from structured analysis results and template information, the generative AI model can more quickly converge on an appropriate response. This reduces processing time on computing hardware and lowers energy consumption. The server also improves accuracy of generated content by using specialized emotion and intent classification modules that provide features tailored for controlled generation. Compared to simply forwarding raw user text, the use of structured analysis result objects and template-based prompt construction reduces the variance of outputs and leads to more consistent and relevant responses.

The server improves data management by representing the user state in structured data structures instead of only unstructured text logs. The analysis result object can be stored, indexed, and retrieved efficiently, enabling later reuse for adaptive prompt construction, personalization, or diagnostic analysis. This improves the way the server hardware manages and accesses memory, compared to systems that store only raw transcripts without semantic decomposition.

The server further reduces communication load between the server and the terminal. Because the server generates responses that are more focused and of controlled length, the number of bytes transmitted per interaction is reduced. Additionally, the server can pre-compute a concise summary of internal analysis to be optionally transmitted to the terminal for display, instead of transmitting full internal state or redundant contextual data. This design optimizes network utilization and improves real-time responsiveness, particularly on constrained or high-latency networks.

The generative AI model in this embodiment utilizes a specific neural network architecture and learning method. During training, a training processor uses a large set of text pairs consisting of prompts and target responses. The training process computes an objective function such as cross-entropy loss between predicted token distributions and ground truth tokens. The training processor updates the model parameters using a gradient-based optimization algorithm, such as stochastic gradient descent with adaptive learning rate. The training procedure may utilize data augmentation techniques, such as synonym replacement or paraphrasing, to improve robustness. The server at inference time benefits from this training by having a model that generalizes well to various user utterances, but the prompt sentence generation mechanism further focuses the model's generative capacity on a narrower task of encouragement and advice.

The server does not simply mimic human decision-making or automate a human counselor's workflow. Instead, the server imposes non-conventional rules for structuring input and controlling model behavior. The server uses algorithmic criteria, such as specific thresholds on emotion_score or confidence values in intent classification, to select templates and to adjust style and length parameters. For example, when the emotion_score exceeds a defined level of negative sentiment, the server increases a “supportiveness” parameter in the template that leads to additional instructions in the prompt sentence, such as “Be especially gentle and reassuring.” This rule-based modulation of template selection and prompt composition is tailored to optimize downstream neural inference, rather than to mirror human decision patterns. The result is a computational pipeline that is tuned to the properties of the generative AI model and that yields an improvement in the joint performance of the server hardware and the model.

In another embodiment, the server uses a different configuration of modules. The server may implement the emotion classification and intent classification using separate models, such as a recurrent neural network classifier or a convolutional neural network classifier, instead of a transformer-based encoder. The server may also implement key phrase extraction by a graph-based ranking algorithm that applies a co-occurrence graph over tokens and ranks nodes using an iterative scoring algorithm. The server can integrate the outputs of these alternative modules into the same analysis result object format, so that the downstream template selection and prompt sentence construction remain unchanged. This modularity allows the server to be adapted to different hardware capabilities or latency constraints while preserving the overall technical effects.

In another embodiment, the terminal performs part of the natural language processing. The terminal may convert audio to text locally using an on-device speech recognition engine, and then send only the text information to the server. The server still performs higher-level analysis, template-based prompt construction, generative AI inference, and filtering. This distribution of computation reduces the amount of raw audio transmitted over the network, which can lower privacy risks and bandwidth usage. The server design in this embodiment remains focused on improving the computational behavior of the generative AI model and the coordination between server and terminal.

In yet another embodiment, the server supports different types of generative AI models. The server may interface not only with a single large language model, but also with specialized smaller models for particular domains such as academic stress or workplace issues. The server selects a model based on the intent_label or key phrase distribution in the analysis result object. This selection reduces overall computational demand by routing tasks to models of appropriate size and capability. By controlling both prompt construction and model selection, the server improves throughput and latency, particularly in environments where many users concurrently access the system.

Through these embodiments, the server, the terminal, and their interaction with the generative AI model produce technical improvements in processing speed, accuracy, data management, and communication efficiency. The described mechanisms, including structured analysis result objects, template-based prompt sentence construction, parameterized control rules, and integrated filtering, provide a concrete implementation path that enables a person skilled in the art to realize the invention in practice using common hardware and software components such as general-purpose processors, audio interfaces, neural network inference frameworks, and communication stacks.

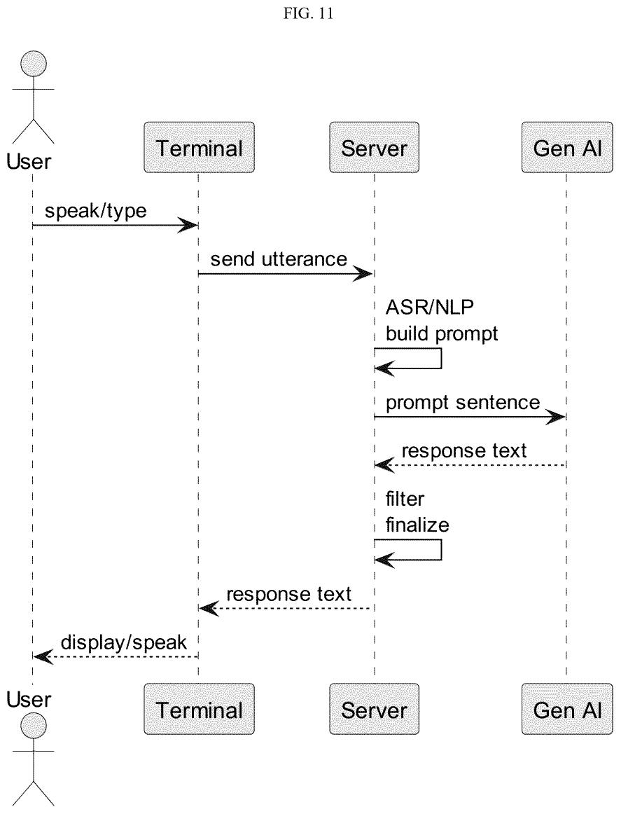

The following describes the processing flow using FIG. 11.

### Step 1

The user provides an utterance as input via an input device.
The user speaks a phrase, such as “Recently my work is not going well and I feel really down,” into a microphone of the terminal, or types a similar sentence into a text input field using a keyboard or touch screen.
The output of this step is analog voice data at the microphone input or a sequence of characters captured by the terminal's text input framework.

### Step 2

The terminal acquires and digitizes the utterance.
The terminal uses an audio recording interface of an operating system to sample the analog voice signal at a predetermined sampling rate and bit depth, thereby converting the analog waveform into digital audio frames. When the input is text, the terminal directly acquires a Unicode character string from the operating system's text input subsystem. Based on the input type, the terminal packages either the digital audio frames or the text string together with metadata such as a user identifier, a language code, and a timestamp into a structured message object.
The input of this step is the analog voice signal or raw typed characters, and the output is a structured message object containing digital audio data or text data and associated metadata.

### Step 3

The terminal transmits the structured message object to the server.
The terminal invokes an HTTP client library to create an HTTPS request and embeds the structured message object into a request body formatted, for example, as JSON or multipart data. The terminal then sends this request to a predefined server endpoint over a network connection, and records a correlation identifier to match a later server response with this request.
The input of this step is the structured message object, and the output is a network request containing the message object delivered to the server's communication interface.

### Step 4

The server receives and normalizes the utterance data.
The server, via a web application framework, terminates the secure communication session, parses the incoming HTTPS request, and extracts the digital audio data or text data plus metadata. The server verifies the format and length of the data and converts audio data to a standard sample rate and encoding if necessary, and converts any text data to a standard character encoding. The server then constructs an internal input object that references the normalized content and the accompanying metadata.
The input of this step is the network request containing the message object, and the output is an internal input object containing normalized audio or text data ready for further processing.

### Step 5

The server converts audio input to text when needed.
When the internal input object indicates that the user provided audio, the server feeds the normalized audio data into an automatic speech recognition module. The server computes acoustic features from the audio signal, applies a trained neural network model to map the feature sequence to character or token probabilities, and decodes the most likely text sequence. The server then attaches the resulting text string to the internal input object as a transcription field.
The input of this step is normalized audio data, and the output is a transcription string that represents the same utterance content in textual form.

### Step 6

The server performs natural language processing to generate an analysis result.
The server tokenizes the text information from the internal input object and computes contextual representations using a text encoder model. Based on these representations, the server applies an emotion classification algorithm to compute probabilities for emotion categories, applies an intent classification algorithm to infer the user's purpose, and applies a key phrase extraction algorithm to select important phrases. The server combines these computed elements into an analysis result object that contains fields for an emotion label, an emotion score, an intent label, and a list of key phrases.
The input of this step is the text information for the user's utterance, and the output is the structured analysis result object encapsulating emotion information, intent information, and key phrase information.

### Step 7

The server selects template information and constructs a prompt sentence.
The server inspects the analysis result object to determine which template pattern to use, taking into account the detected emotion label and intent label. The server fills template placeholders with values derived from the analysis result, such as converting the emotion label into descriptive terms and concatenating key phrases into a short problem description. The server also embeds control instructions, such as required tone or length, into the same text. The server thereby generates a complete prompt sentence that explicitly instructs a generative AI model how to produce an appropriate response.
The input of this step is the analysis result object and stored template information, and the output is a prompt sentence text string to be used as input to the generative AI model.

### Step 8

The server inputs the prompt sentence to the generative AI model and generates a response sentence.
The server forwards the prompt sentence to a generative AI model implementation, either as a local model or via a model inference service. The server causes the model to encode the prompt sentence into internal token embeddings, propagate these embeddings through multiple network layers, and decode an output token sequence that forms a candidate response. The server concatenates the generated tokens into a coherent text segment that contains encouragement or advice addressing the user's situation.
The input of this step is the prompt sentence, and the output is a raw response sentence generated by the generative AI model.

### Step 9

The server performs filtering processing and finalizes the response sentence.
The server analyzes the raw response sentence using one or more safety and appropriateness checks, such as applying rule-based filters and classification models that detect harmful or policy-violating phrases. When the server detects problematic content, the server either edits the text by removing or replacing specific segments or regenerates the response by invoking the generative AI model with an adjusted prompt sentence that includes additional constraints. The server marks the resulting safe and appropriate text as the final response sentence to be sent to the terminal.
The input of this step is the raw response sentence from the generative AI model, and the output is a filtered response sentence that satisfies predefined safety and appropriateness criteria.

### Step 10

The server transmits the finalized response sentence to the terminal.
The server packages the filtered response sentence into a response message, adds any needed metadata such as emotion information or a reference identifier, and serializes this information into a response body. The server then sends an HTTPS response to the terminal using the same or a related connection that carried the original request.
The input of this step is the filtered response sentence, and the output is a network response message containing the response sentence delivered to the terminal.

### Step 11

The terminal determines a presentation mode and prepares output.
The terminal receives the response message, parses the response body to extract the response sentence, and consults internal setting information and any recent operation information from the user interface, such as whether an audio mode toggle is enabled. Based on this information, the terminal decides whether to present the response sentence as text, as synthesized speech, or as both. The terminal then formats the text for display or passes it to a speech synthesis engine as required.
The input of this step is the response message containing the response sentence, and the output is presentation parameters and formatted content ready for display or audio rendering.

### Step 12

The terminal presents the response sentence to the user.
The terminal renders the response sentence as text on a display device, for example by writing the string into a message view and updating the graphical display. When audio output is selected, the terminal generates an audio waveform from the text using a text-to-speech engine and sends the waveform to an audio subsystem, which drives speakers or headphones. The user then perceives the content and may react with a new utterance that re-enters the system at the first step.
The input of this step is the formatted response sentence and presentation parameters, and the output is a visual or auditory presentation of the response sentence delivered to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional customer-assistance systems that utilize speech recognition and rule-based dialogue engines often suffer from several technical limitations. First, such systems generally treat speech recognition, language understanding, and response generation as loosely coupled components, resulting in latency, inconsistent output quality, and inefficient use of computing resources. For example, recognized text is frequently passed to a generic dialogue engine without rich contextual features such as the user's emotional state or inferred needs, causing sub-optimal generation of guidance messages and necessitating repeated server-side processing to correct or supplement responses.

Second, existing systems typically do not construct prompt sentences for generative AI models in a structured and dynamic manner based on fine-grained natural language analysis. Instead, they rely on static templates or simple concatenation of user utterances, which fails to fully exploit the capabilities of generative models. As a result, the generated output often lacks appropriate tone control, length control, and content constraints aligned with user context, leading to user confusion and increased interaction time.

Third, conventional architectures rarely close the loop between past interactions and subsequent prompt generation logic. Dialogue history, when stored at all, is often archived merely for analytics and is not used as real-time training data or configuration data to adapt natural language processing parameters and prompt construction rules. This leads to a technical shortcoming in that the system cannot efficiently improve the precision and consistency of its generative output under constrained computational budgets, especially in real-time environments such as physical stores where latency and display constraints are strict.

Furthermore, in head-mounted or mobile visual interfaces, there is a technical challenge in optimizing the data pipeline from audio capture, through server-side processing, to compact visual output that is suitable for restricted display areas and for minimal cognitive load on the user. Existing solutions do not adequately integrate emotional state estimation, intent estimation, and prompt optimization to minimize unnecessary data transfer and processing, or to generate responses whose information density and tone are tailored to the particular display and interaction environment.

Accordingly, there is a need for an improved computer-implemented system and server-side processing method that: (i) tightly integrates speech recognition, multi-stage natural language processing, and generative AI model invocation; (ii) dynamically constructs and adjusts prompt sentences based on estimated user needs and emotional states; and (iii) leverages dialogue history to adapt natural language processing parameters and prompt construction rules. Such a system should technically improve the efficiency, consistency, and responsiveness of generating encouragement and advice messages, particularly in real-time customer-service contexts with constrained display resources.

The specific processing by the specific processing unit 290 of the data processing device 12 in Application Example 1 is realized by the following means.

The present invention provides a server comprising a processor and a memory storing instructions that, when executed by the processor, cause the server to receive acoustic signals representing user utterances from a mobile terminal through a communication network; to convert the acoustic signals into character string data by executing a speech recognition program; to execute natural language processing including at least morphological analysis, syntactic analysis, emotion estimation, and intent estimation on the character string data so as to generate analysis result data representing a need and an emotional state of the user; to construct, based on the character string data and the analysis result data, a structured prompt sentence including constraints on style, length, and content to be input to a generative language model; to supply the prompt sentence to the generative language model and obtain a response sentence representing encouragement or advice; to format the response sentence as output data adapted for visual presentation on the mobile terminal; and to store dialogue history data associating the analysis result data with the response sentence and update at least one of prompt-construction parameters and natural language processing parameters on the basis of the dialogue history data. This enables an improvement in computer functionality by reducing end-to-end latency, enhancing consistency and contextual appropriateness of generated responses, and efficiently adapting the speech-to-generation pipeline to user needs and emotional states, thereby providing more effective real-time customer-assistance outputs within constrained mobile or head-mounted display environments.

The term “processor” refers to a hardware computing element or a combination of hardware computing elements configured to execute instructions, including one or more central processing units, graphics processing units, or specialized accelerators.

The term “memory” refers to a non-transitory computer-readable storage medium configured to store instructions and data for access by the processor, including volatile storage and non-volatile storage.

The term “audio input device” refers to an input apparatus configured to capture sound waves and convert the sound waves into electrical or digital signals, including a microphone or an array of microphones.

The term “mobile information terminal” refers to a portable electronic device configured to communicate over a communication network and to execute application software, including a smartphone, a tablet terminal, or a head-mounted wearable device.

The term “server apparatus” refers to a computing system configured to provide processing or storage services to one or more client devices via a communication network, and may include one or more physical or virtual server machines.

The term “communication network” refers to a wired or wireless data transmission infrastructure configured to convey digital information between the mobile information terminal and the server apparatus, including local area networks, wide area networks, and public networks.

The term “acoustic signal” refers to a time-varying electrical or digital representation of sound captured from a user utterance by the audio input device.

The term “speech recognition program” refers to software logic configured to convert an acoustic signal into character string data representing recognized text, using acoustic models, language models, or pattern recognition algorithms.

The term “character string data” refers to a sequence of machine-readable characters representing textual information obtained from speech recognition or other input sources.

The term “natural language processing” refers to a set of computational techniques configured to analyze and interpret human language text, including at least morphological analysis, syntactic analysis, emotion estimation, and intent estimation.

The term “morphological analysis” refers to a processing operation that segments character string data into tokens and identifies lexical attributes such as word stems, inflectional forms, or parts of speech.

The term “syntactic analysis” refers to a processing operation that determines structural relationships between tokens in character string data, including dependency relations or phrase structures.

The term “emotion estimation” refers to a processing operation that infers an emotional state of a user, such as positivity, negativity, neutrality, anxiety, or hesitation, from character string data.

The term “intent estimation” refers to a processing operation that infers a communicative purpose or goal of a user utterance, such as requesting information, seeking reassurance, or evaluating a product.

The term “analysis result data” refers to structured data generated by natural language processing that represents at least a need and an emotional state of the user or other attributes derived from the character string data.

The term “need” refers to an inferred requirement, interest, or concern of the user identified from a user utterance, including a desire for information, guidance, or evaluation regarding an item or situation.

The term “emotional state” refers to an inferred affective condition of the user, such as confidence, uncertainty, anxiety, satisfaction, or hesitation, derived from analysis of a user utterance.

The term “prompt sentence” refers to a text sequence constructed as input to a generative language model, the text sequence including contextual information, constraints, or instructions that guide generation of an output sentence.

The term “structured prompt sentence” refers to a prompt sentence organized according to predefined components, such as role description, contextual description, user utterance, and explicit constraints on style, length, or content.

The term “generative language model” refers to a trained machine learning model configured to generate natural language text in response to input text, including autoregressive models, sequence-to-sequence models, or transformer-based models.

The term “response sentence” refers to text generated by the generative language model in response to a prompt sentence and representing encouragement, advice, or other assistance content.

The term “encouragement” refers to a response sentence that provides supportive, confidence-building, or reassuring content to the user.

The term “advice” refers to a response sentence that provides recommendations, suggestions, or guidance to the user regarding an item, action, or decision.

The term “output data” refers to data formatted for delivery from the server apparatus to the mobile information terminal and representing at least one response sentence for presentation to the user.

The term “display device” refers to a visual output apparatus associated with the mobile information terminal that is configured to present graphical or textual information to the user, including a head-mounted display, a liquid crystal display, or an organic light-emitting diode display.

The term “visual information” refers to information encoded as images, text, or graphical elements suitable for presentation on the display device.

The term “dialogue history data” refers to stored data that associates analysis result data, user utterances, and response sentences across multiple interactions to represent a history of exchanges between the user and the system.

The term “attribute information” refers to metadata included in the analysis result data that characterizes aspects of a user utterance, including at least the need and the emotional state of the user.

The term “storage device” refers to a hardware component configured to retain data for later retrieval, including a magnetic storage device, a solid-state storage device, or a network-attached storage system.

The term “prompt-construction parameters” refers to configuration values used by the processor to determine how to assemble components of a prompt sentence, including parameters that control inclusion, ordering, or weighting of contextual elements.

The term “natural language processing parameters” refers to configuration values or model weights used to control behavior of natural language processing components, including thresholds, feature weights, or model selection indicators.

The term “generation performance” refers to characteristics of the output of the generative language model, including accuracy relative to user needs, contextual appropriateness, consistency of tone, and response latency.

In one embodiment, a system includes a server and one or more terminals. The server includes at least one processor and at least one non-transitory memory storing instructions. The terminal includes at least one processor, an audio input device such as a microphone, a wireless communication interface, and a display device such as a head-mounted display or handheld display.

The terminal acquires a user utterance in a physical environment, for example in a store, and converts the utterance into an acoustic signal. The terminal executes an audio capture module that samples the acoustic signal at a predetermined sampling rate (e.g., 16 kHz, 16-bit linear PCM), performs framing and optional noise suppression, and stores the resulting digital audio frames in a ring buffer in a local memory. The terminal associates metadata such as device identifier, timestamp, and language code with the digital audio frames and transmits these audio packets to the server through a communication interface, for example a wireless local area network or mobile communication network.

The server receives the audio packets and executes a speech recognition module. In one example, the server calls a cloud-based speech recognition service such as a generic speech-to-text application programming interface, which internally applies an acoustic model and a language model to decode the acoustic features into text. In another example, the server executes a local speech recognition engine implementing a deep neural network acoustic model, such as a recurrent neural network or a convolutional neural network trained on speech data. The server converts the acoustic signal into character string data representing one or more recognized sentences. The server may normalize the text by removing disfluencies, unifying punctuation, and converting between character sets.

The server then executes a natural language processing module implemented, for example, by a library such as a general-purpose natural language processing toolkit (e.g., a library similar to spaCy) running in a scripting language environment. The server applies tokenization to segment the character string data into word tokens or subword tokens, and applies morphological analysis to determine part-of-speech tags and lemma forms. The server applies syntactic analysis, such as dependency parsing, to derive a tree or graph structure that represents grammatical relations among tokens. The server extracts key phrases relating to products, user evaluations, and question forms by following specific dependency patterns and part-of-speech sequences, and generates a structured representation such as an internal object containing fields for product terms, adjectives, and question indicators.

The server executes an emotion estimation submodule that computes an emotional state score vector for the user utterance. In one embodiment, the server uses a shallow neural classifier that receives, as input features, a concatenation of token embeddings (for example, pre-trained word embeddings), sentiment lexicon scores, and syntactic pattern indicators. The classifier outputs probability values for several emotion categories such as “uncertain,” “anxious,” “confident,” and “neutral.” The server selects the emotion label with the highest probability and stores it in analysis result data. In another embodiment, the server applies a rule-based classifier that uses non-conventional rules tuned for real-time customer support, for example treating combinations of question particles and specific adverbs as strong indicators of uncertainty.

The server executes an intent estimation submodule that determines the user's communicative purpose, such as asking about product suitability, asking about price, or seeking reassurance. The server uses a multi-class classifier implemented with, for example, a feedforward neural network or a support vector machine trained on intents, and uses features derived from the tokenized text, dependency relations, and keyword presence. The server outputs an intent label and confidence score and stores them in the analysis result data together with the emotional state and extracted key phrases.

The server constructs analysis result data as a structured data object that includes at least: original text, estimated intent, estimated emotional state, product-related expressions, and contextual attributes such as store type or interaction stage. The server stores this analysis result data in a volatile memory for immediate use in prompt construction and may also log it in a persistent storage for building dialogue history.

The server then executes a prompt construction module. The server generates a prompt sentence to be supplied to a generative AI model, such as a generative language model having a transformer-based neural network architecture. The generative language model may be a multi-layer self-attention model trained on large-scale text corpora using an autoregressive objective, where each layer comprises multi-head attention sublayers and position-wise feedforward sublayers. The server does not treat the prompt as a simple concatenation of user text, but instead builds a structured prompt containing distinct sections: (i) a role description, (ii) a context description, (iii) an explicit quotation of the user's utterance, and (iv) explicit constraints on style, length, and content.

The server selects a role description template, such as “You are a polite and supportive store clerk in a physical store.” The server selects or generates a context description based on the intent and emotional state, such as “The customer is hesitating about whether a product suits them and feels uncertain.” The server inserts the original user utterance inside quotation marks and identifies it as the customer's utterance. The server applies predetermined rules and parameters to add constraints, such as “Provide one short, encouraging sentence in [language] that reassures the customer and supports their decision, without being pushy.” These prompt-construction parameters include, for example, maximum sentence count, tone (polite, neutral), and explicit prohibitions on certain phrase types.

The server concatenates these components in a defined order separated by line breaks. One example of such a prompt sentence is:

You are a polite and supportive store clerk in a physical store.

The customer is hesitating about whether a product suits them and feels uncertain.

Customer's utterance: “I wonder if this product suits me”

Provide one short, encouraging sentence in Japanese that reassures the customer and supports their decision, without being pushy.

In another example, the server constructs a prompt sentence for a case where a user is worried about price:

You are a considerate sales clerk.

The customer is interested in a product but is worried about the price and feels conflicted.

Customer's utterance: “I want it, but it might be a bit expensive”

Provide one brief and empathetic reply in Japanese that acknowledges the concern and offers positive, supportive advice without pressuring the customer.

In still another example, the server constructs a prompt sentence for cosmetics advice:

You are a beauty advisor in a cosmetics shop.

The customer is anxious about whether a new foundation matches their skin tone.

Customer's utterance: “ I'm worried whether the color suits me”

Provide one concise and encouraging sentence in Japanese that reassures the customer and suggests a simple next step, such as trying it on or comparing shades.

The server transmits the prompt sentence to the generative language model. In one embodiment, the server sends a request through a secure network connection to a remote inference service that hosts the generative language model. The request includes the prompt sentence, a model identifier, and generation parameters such as maximum token count, temperature, and top-k or top-p sampling thresholds. The generative language model then performs forward propagation through its transformer layers, computing attention scores and weighted sums of hidden states to predict the next token at each step until an end-of-sequence token or maximum length is reached. The server receives the generated token sequence and decodes it into a response sentence representing encouragement or advice.

The server then executes a post-processing module that enforces additional constraints on the response sentence. The server may check the sentence length and truncate or regenerate the response if it violates a maximum token threshold. The server may apply a tone normalization algorithm that replaces slang or overly casual expressions with polite forms, using a predefined mapping table. The server may apply a content filter, implemented as a classifier or rule set, to detect and remove undesirable content. The result is formatted as output data, which may be encoded in a lightweight message format suitable for transmission over constrained networks.

The server transmits the output data to the terminal. The terminal receives the output data and executes a display rendering module. The terminal extracts the response sentence and renders it on the display device as an overlay or pop-up text, adjusting font size, contrast, and placement to avoid occluding important parts of the user's field of view. The terminal may maintain a small cache of recent messages in a local memory to allow rapid replacement and to avoid re-rendering static content.

The server further stores dialogue history data in a storage device. The dialogue history data associates analysis result data (intent, emotional state, product terms) with corresponding response sentences and additional context such as interaction time and outcome indicators. The server periodically executes an adaptation module that reads batches of dialogue history data and updates prompt-construction parameters and natural language processing parameters. For example, the server may adjust thresholds used in emotion estimation, update weights in intent classifiers, or modify the selection logic for templates used in role and context descriptions. The server may also retrain or fine-tune the emotion and intent classifiers on the accumulated dialogue history, using a supervised learning procedure with a loss function such as cross-entropy and weight updates computed by stochastic gradient descent or an adaptive optimization algorithm. By focusing on low-latency, high-accuracy prediction under the specific distribution of store interactions, the server improves the technical performance of the natural language processing pipeline.

The server improves computer technology in several ways. By integrating speech recognition, fine-grained natural language analysis, and structured prompt construction into a single pipeline optimized for real-time operation, the server reduces end-to-end latency compared to loosely coupled systems that pass raw text to generic dialogue engines. Because the server constructs the prompt sentence using explicit, structured components and adjusts style, length, and content constraints according to the analysis result data, the generative language model is provided with a more informative and constrained input. This reduces the search space during decoding in the generative language model, thereby decreasing the average number of candidate paths considered in sampling and improving computational efficiency.

The server further reduces communication load by transmitting compact acoustic features and compact textual responses rather than heavy multimedia data. The analysis result data and dialogue history data are stored in structured, indexed formats, enabling efficient retrieval and batch adaptation of models without scanning raw logs. The adaptation module uses non-conventional rules that prioritize features empirically shown to affect generative performance in a head-mounted display context, such as emotional state boundaries and hesitation phrases, thereby improving accuracy and consistency of generated responses.

The system does not merely automate a human clerk's behavior; instead, the server controls machine-specific components and data structures in ways that a human cannot. The server uses specific neural network architectures, feature encodings, and adaptation mechanisms to exploit the capabilities of generative AI models while controlling computational resources and communication overhead. In particular, the server's use of dialogue history to adjust prompt-construction parameters in real time improves the computer's ability to condition generative outputs on long-term patterns without requiring retraining of the generative language model itself, thereby enabling faster convergence and lower resource consumption.

In another embodiment, the server executes an on-premise generative language model hosted on local graphics processing units. The server partitions the model layers across multiple processors and pipelines the attention computations to minimize inference latency. The server may quantize weights in selected layers to lower precision to reduce memory footprint and improve cache utilization, thereby further improving throughput. The prompt construction and post-processing modules remain as described but may be adjusted to generate shorter prompts and responses when bandwidth or latency constraints are stricter.

In another embodiment, the terminal includes additional sensors such as a camera or gaze tracker. The server may incorporate sensor-derived features into the analysis result data, for example by updating the emotional state estimate based on facial expressions or gaze patterns. The prompt construction module then generates more targeted constraints, such as explicitly requesting very short replies when the user is looking away from the display. This multi-modal integration changes the internal data flow and improves the effective use of the limited display area by reducing unnecessary information.

In yet another embodiment, the system is deployed in a different environment such as remote technical support or medical consultation assistance. The server continues to execute the same core modules-speech recognition, natural language processing, structured prompt construction, generative language model inference, post-processing, and adaptation on dialogue history. The specific templates, vocabulary, and classification labels for intent and emotional state may be changed to suit the domain, but the technical effect of improved latency, accuracy, and resource usage remains.

By combining these components and processing flows, the server and terminal cooperate to implement a concrete, technical solution that acquires user utterances, processes them using computer-implemented natural language and emotional analysis, generates optimized prompt sentences for a generative AI model, and returns concise, context-appropriate visual guidance on a constrained display device with improved speed and accuracy.

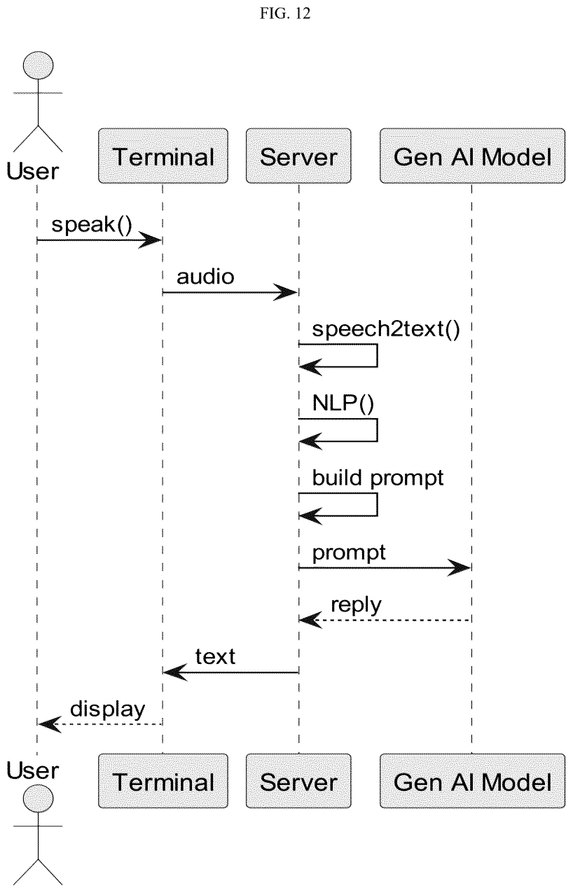

The following describes the processing flow using FIG. 12.

### Step 1

The user produces a spoken utterance in a real environment, for example in a store, while wearing or holding the terminal.
The terminal uses its audio input device to capture the utterance as an analog sound wave and converts it into a digital acoustic signal. As input, the terminal receives continuous sound pressure variations from the user's voice. The terminal performs analog-to-digital conversion, samples the signal at a predetermined sampling rate (for example, 16 kHz, 16-bit), segments the stream into fixed-length audio frames (for example, 20-40 ms per frame), and applies optional pre-processing such as noise suppression or echo cancellation. As output, the terminal generates a sequence of digital audio frames accompanied by metadata such as timestamps and device identifiers, and stores these frames in a buffer in a local memory.

### Step 2

The terminal transmits the captured audio data to the server over a communication network.
The terminal uses its communication interface to establish a secure connection, for example via a wireless local area network or cellular network. As input, the terminal takes the buffered digital audio frames and associated metadata. The terminal encapsulates the frames into one or more data packets, attaches headers including session identifiers and language codes, and sends the packets to a predefined server address using a transport protocol such as TCP over TLS. As output, the terminal produces a stream of network packets that carry the user's acoustic signal and metadata to the server.

### Step 3

The server receives the audio data and converts it into character string data by executing a speech recognition process.
The server uses a communication module to accept incoming packets and reconstruct the original sequence of digital audio frames. As input, the server receives the network packets from the terminal. The server reorders packets if needed, removes protocol headers, and concatenates the payloads into a continuous audio stream. The server then invokes a speech recognition engine, which may be a local program or a remote speech-to-text service. The engine extracts acoustic features (for example, Mel-frequency cepstral coefficients) from the audio frames, applies an acoustic model and a language model, and performs decoding to map the feature sequence to a sequence of symbols representing words or subwords. As output, the server generates character string data representing the recognized text of the user's utterance and may also output confidence scores for each segment.

### Step 4

The server performs natural language processing on the character string data to derive analysis result data.
The server loads a natural language processing library and applies a sequence of text analysis operations. As input, the server receives the recognized character string data. The server executes tokenization to segment the text into tokens, executes morphological analysis to assign part-of-speech tags and lemma forms to each token, and executes syntactic analysis such as dependency parsing to compute grammatical relations between tokens. The server then runs an emotion estimation submodule that uses features derived from tokens, part-of-speech tags, dependency patterns, and emotion lexicon scores to compute a probability distribution over predefined emotional categories. The server selects an emotional state label based on the highest probability. The server further runs an intent estimation submodule that uses text-based features and pattern indicators to classify the intent of the utterance, such as “ask about product suitability” or “express concern about price.” As output, the server produces analysis result data, which includes at least the original text, the estimated emotional state, the estimated intent, and extracted key phrases such as product-related terms.

### Step 5

The server constructs a structured prompt sentence for a generative AI model based on the character string data and the analysis result data.
The server executes a prompt construction module that uses templates and configuration parameters. As input, the server receives the recognized text and the analysis result data including intent, emotional state, and key phrases. The server selects a role description string, such as “You are a polite and supportive store clerk in a physical store,” and a context description string that reflects the detected intent and emotional state, such as “The customer is hesitating about whether a product suits them and feels uncertain.” The server then embeds the original user utterance, labeling it explicitly as the customer's utterance, and appends constraint sentences that specify style, length, and content limitations, such as “Provide one short, encouraging sentence in Japanese that reassures the customer and supports their decision, without being pushy.” The server concatenates these components in a predefined order with separators. As output, the server generates a complete prompt sentence to be input to the generative AI model.

### Step 6

The server transmits the prompt sentence to the generative AI model and obtains a response sentence.
The server prepares a request to an inference interface of the generative AI model, which may be hosted locally or remotely. As input, the server uses the constructed prompt sentence and model control parameters such as maximum token length, sampling temperature, and top-p value. The server encodes the prompt sentence into a suitable character encoding and sends it as part of a request message. The generative AI model processes the prompt by propagating token embeddings through multiple network layers, computing attention weights and updated hidden states to predict successive output tokens. The server receives a sequence of token identifiers representing the generated text and decodes them into a response sentence. As output, the server obtains textual encouragement or advice corresponding to the user's utterance and context.

### Step 7

The server performs post-processing on the response sentence and formats output data for the terminal.
The server applies a post-processing module that enforces stylistic and length constraints. As input, the server receives the raw response sentence from the generative AI model and the analysis result data, which includes the emotional state and intent. The server checks the length of the response against a predefined maximum and truncates or regenerates the response if it exceeds that limit. The server scans the response for informal expressions or disallowed terms and replaces them with polite or neutral alternatives according to a mapping dictionary. The server may also add metadata such as an interaction identifier, timestamps, and the emotion label. As output, the server generates output data comprising the finalized response sentence and associated metadata, encoded in a compact format suitable for transmission to the terminal.

### Step 8

The server stores dialogue history data for future adaptation and sends the output data to the terminal.
The server uses a storage module to record interactions. As input, the server receives the analysis result data and the finalized response sentence. The server creates a dialogue record that associates the user's recognized text, the estimated emotional state, the estimated intent, the prompt construction parameters used, and the generated response. The server writes this record into a storage device in a structured format with indices to enable efficient retrieval. In parallel, the server transmits the output data to the terminal over the communication network. As output, the server produces an updated dialogue history database and a network message containing the response sentence and metadata for the terminal.

### Step 9

The terminal receives the output data and displays the response sentence to the user.
The terminal uses its communication interface to receive messages from the server. As input, the terminal obtains the output data containing the response sentence and associated metadata. The terminal parses the data structure, extracts the text of the encouragement or advice, and passes it to a display rendering module. The terminal computes layout parameters such as font size, line breaks, and screen position, taking into account the current state of the display and, where applicable, the user's field of view. The terminal then renders the text as an overlay, for example in the corner of a head-mounted display or at the top of a handheld screen, with sufficient contrast and minimal obstruction. As output, the terminal presents the generated message visually to the user in real time.

### Step 10

The user views the displayed response and optionally engages in further interaction.
The user reads the encouragement or advice shown on the terminal's display and may decide to speak again in response to customer behavior or to ask a follow-up question. As input, the user receives the visual information and incorporates it into their decision-making process. If the user speaks another utterance, the terminal captures the new acoustic signal and repeats the processing flow beginning from Step 1. As output, the user produces additional utterances that trigger subsequent iterations of the system's processing, enabling continuous, context-aware support.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented dialogue systems and support systems have difficulty accurately reflecting a user's emotional state in automatically generated responses. In typical architectures, a speech recognition component converts speech to text, and a separate response generation component produces a reply based largely on surface-level text. Such systems often lack an integrated mechanism that transforms raw audio data into structured emotional information and then conditions a generative model on that emotional information in a technically consistent, machine-understandable manner. As a result, generated responses may be generic, poorly aligned with the user's emotional condition, and may require additional manual tuning or rule-based scripting, which increases system complexity and reduces adaptability.

Furthermore, in known systems, the interaction between audio acquisition, natural language processing, emotion estimation, and generative response output is often loosely coupled, with individual components operating in isolation. This fragmented processing pipeline can cause inefficiencies such as redundant data transformations, increased latency, and inconsistent use of emotional context. In addition, conventional systems generally do not use structured emotion metadata, such as emotion categories and associated confidence degrees, to programmatically shape the prompt sentences sent to a generative AI model. Without this structured control, the internal behavior of the generative AI model cannot be reliably guided, resulting in unstable response quality and difficulty in optimizing the system performance.

There is also a need to improve computer technology in terms of how a processor configures and updates prompts to a generative AI model over time, based on user-specific factors. Existing systems typically do not systematically adjust parameters such as writing style, response length, concreteness level, and topic range of generated text in response to accumulated interaction histories. Consequently, the computing resources of generative models are not efficiently utilized, and the system fails to adapt its behavior at the machine level to different emotional patterns and long-term user states, leading to suboptimal personalization and increased computational overhead due to ineffective prompt design.

Accordingly, there is a demand for a computer-implemented system and method that provide an improved technical mechanism to: (i) capture a user's spoken input as digital audio information on a terminal; (ii) perform server-side speech recognition and natural language processing to derive structured emotional information; (iii) construct and dynamically adjust prompt sentences for a generative AI model based on the structured emotional information and interaction history; and (iv) cause generation and presentation of encouragement or advice that is consistently aligned with the estimated emotional state. Such a system should improve the technical functioning of the overall dialogue architecture by reducing redundant processing, enabling fine-grained control of generative model behavior, and enhancing the efficiency and reliability of emotion-aware response generation by a processor.

The specific processing by the specific processing unit 290 of the data processing device 12 in Example 2 is realized by the following means.

The present invention provides a server comprising a processor configured to receive, via a communication interface, digital audio information corresponding to a user utterance captured at a terminal, execute a speech recognition process on the digital audio information to generate character information, execute natural language processing on the character information to estimate an emotional state of the user and to generate structured information including an emotion category and a confidence degree, generate a prompt sentence for input to a generative information processing model based on the character information and the structured information, input the prompt sentence to the generative information processing model to cause generation of response information including encouragement or advice corresponding to the emotional state, and transmit the response information to the terminal for presentation to the user. This enables an integrated, processor-controlled pipeline in which audio acquisition, emotion estimation, and prompt sentence construction are technically coordinated to guide the generative AI model using structured emotional metadata, thereby improving the efficiency, reliability, and personalization of emotion-aware response generation in a computer-implemented dialogue system.

The term “system” refers to a combination of one or more computing devices, communication devices, and peripheral devices that cooperatively execute processing steps to implement the described functions.

The term “processor” refers to one or more hardware processing units, such as a central processing unit or a graphics processing unit, configured to execute instructions stored in a memory to perform the claimed operations.

The term “server” refers to a computing apparatus, including at least one processor and a memory, configured to provide processing services and data management for one or more terminals over a communication network.

The term “terminal” refers to a user-facing computing apparatus, such as a portable information device or a stationary information device, configured to capture user input, communicate with the server, and present information to the user.

The term “user” refers to a human operator who interacts with the terminal by providing utterances and receiving information output from the system.

The term “input device” refers to a hardware or software component, such as a microphone or a graphical user interface control, configured to receive input from the user.

The term “audio signal” refers to an analog or digital representation of sound, including spoken utterances of the user, that can be processed by audio circuitry or software.

The term “digital audio information” refers to data representing an audio signal in a discrete, quantized format suitable for processing by a computing device.

The term “communication device” refers to hardware and software components, such as network interfaces and communication protocols, configured to transmit and receive data between the server and the terminal.

The term “speech recognition process” refers to a computational procedure that converts digital audio information representing spoken language into character information representing text.

The term “character information” refers to data representing text, including sequences of characters, symbols, or tokens corresponding to words or phrases obtained from a user utterance.

The term “natural language processing” refers to a set of computational techniques for analyzing and processing character information expressed in a human language, including tasks such as tokenization, parsing, semantic analysis, and emotion estimation.

The term “emotional state” refers to an internal condition of the user, such as being worried, sad, happy, angry, or neutral, inferred from the user's utterance by computational analysis.

The term “emotion category” refers to a predefined label representing a type of emotional state, which is assigned to the user's utterance by an emotion estimation process.

The term “confidence degree” refers to a numerical or ordinal value indicating the reliability or likelihood that a particular emotion category correctly represents the user's emotional state.

The term “structured information” refers to data organized according to a defined format, such as a record or object including fields for an emotion category and a confidence degree, which can be programmatically processed by the system.

The term “prompt sentence” refers to a text sequence including instructions, context, or constraints, generated by the processor and supplied as input to a generative information processing model to control the behavior of that model.

The term “generative information processing model” refers to a trained computational model, such as a machine learning model, configured to generate text or other output data in response to an input including a prompt sentence.

The term “response information” refers to output data generated by the generative information processing model, including text representing encouragement or advice corresponding to the user's emotional state.

The term “encouragement or advice” refers to informational content intended to support, reassure, or guide the user, generated based on the user's emotional state and utterance.

The term “display device” refers to hardware, such as a screen or monitor, and associated software configured to visually present information, including response information, to the user.

The term “voice output device” refers to hardware, such as a speaker or headphone, and associated software configured to output audio signals representing synthesized speech or other sounds to the user.

The term “interaction history” refers to stored data representing past exchanges between the user and the system, including past utterances, emotional states, prompt sentences, and response information.

The term “writing style” refers to characteristics of generated text, including tone, formality level, sentence structure, and vocabulary selection, which can be adjusted by modifying a prompt sentence.

The term “response length” refers to a quantitative measure of the size of generated text, such as a number of characters, words, or sentences included in the response information.

The term “degree of concreteness” refers to a property of generated text indicating how specific or abstract the content is, including the level of detail and the presence of concrete examples or actionable steps.

The term “topic range” refers to a scope of subject matter that the generated text is allowed or instructed to cover, as specified or constrained in the prompt sentence.

In one embodiment, the system includes a server, one or more terminals, and a communication network that couples the server and the terminals. The server includes at least one processor and at least one memory storing instructions that, when executed by the processor, cause the server to perform the operations described below. The terminal includes at least one processor, a memory, an input device such as a microphone, a display device, and optionally a voice output device such as a speaker or headphone.

The terminal acquires a user utterance as an audio signal. The terminal uses an audio capture interface provided by an operating system, such as an audio engine or media framework, to sample an analog voice signal from the microphone at a predetermined sampling rate, for example 16 kHz or 44.1 kHz, and to quantize the signal into digital audio information, for example 16-bit pulse code modulated (PCM) data. The terminal stores the sampled data in a buffer in memory, such as a circular buffer or a frame-based buffer structure. The terminal optionally applies signal processing operations, such as noise reduction, echo cancellation, and voice activity detection, using an audio processing library or media framework. These operations reduce background noise, remove echo artifacts, and detect speech segments, thereby improving the accuracy and computational efficiency of subsequent recognition processing at the server.

The terminal transmits the digital audio information to the server over the communication network. The terminal uses a communication device, such as a wireless communication interface or wired network interface, and a protocol stack implementing a transport protocol and an application protocol, for example a secure hypertext transfer protocol. The terminal may include in a header or metadata region information indicating the audio format, sampling rate, encoding type, language code, and a session identifier. This explicit formatting enables the server to standardize the received audio into a format optimized for recognition, thereby reducing the need for repeated format conversions and lowering latency.

The server receives the digital audio information via a communication interface. The server stores the received audio in a memory or in a non-transitory storage device. The server can normalize the audio format using an audio processing library, for example by resampling to a standard sampling rate, converting to mono, and ensuring a unified bit depth. The server thereby ensures that a speech recognition component receives consistent input data, which stabilizes the performance of the recognition algorithm and improves processing speed, because parameter reconfiguration and model switching based on variable audio formats is avoided.

The server executes a speech recognition process on the digital audio information. In one embodiment, the server uses software implementing an acoustic model and a language model, such as a hidden Markov model-based recognizer or a neural network-based recognizer. The acoustic model may be a deep neural network, such as a convolutional neural network (CNN), a recurrent neural network (RNN), or a transformer-based model, trained on a large corpus of labeled speech data. The language model may be an n-gram model or a neural language model. The server converts the audio frames into acoustic features, such as Mel-frequency cepstral coefficients (MFCCs) or log Mel-spectrograms. The server feeds the acoustic features into the acoustic model, computes posterior probabilities over phonetic units, applies decoding with the language model, and outputs character information representing recognized text. The server may use beam search decoding and pruning to reduce computational complexity while maintaining recognition accuracy. By implementing this structured feature extraction and decoding pipeline, the server improves recognition accuracy and reduces error rates relative to simple template matching or keyword spotting schemes.

The server performs natural language processing on the character information to estimate an emotional state of the user. In one embodiment, the server tokenizes the character information into tokens, sub-word units, or wordpieces, using a tokenizer associated with a neural language model. The server then maps the tokens to numerical identifiers and generates embedding vectors. The server inputs the embeddings into a neural network-based emotion classification model. The emotion classification model may be a transformer-based model, such as a bidirectional encoder with multiple self-attention layers, trained to output an emotion category distribution. Typical emotion categories include, for example, “happy,” “sad,” “worried,” “angry,” “frustrated,” and “neutral,” but the categories can be extended or modified depending on use cases.

The server computes, for each emotion category, a probability score representing a confidence degree that the user's utterance belongs to that category. The server then selects the emotion category with the highest probability as a primary emotional state and may retain secondary categories above a threshold for additional nuance. The server represents this information as structured information, such as a record including at least an emotion category field, a confidence degree field, and an identifier linking the structure to the original character information. The server thereby converts unstructured text into machine-usable emotion metadata, which can be processed deterministically in subsequent steps. This structured representation enables the processor to adjust the behavior of a downstream generative AI model in a controlled manner, rather than merely passing raw text or arbitrary qualitative labels.

The server generates a prompt sentence for input to a generative information processing model, based on the character information and the structured information. The server uses a prompt construction module implemented in software. The server may store a set of templates that define how to combine elements such as the user utterance, the emotion category, and system instructions. The server selects a template based on the emotion category, the confidence degree, and optionally user profile information. The server fills in the template with the actual character information and emotion values. For example, the server may generate a prompt sentence such as:
“You are an assistant that provides emotional support.
The user utterance is: ‘Recently, my work hasn't been going well and I'm really worried.’
The estimated emotion is: ‘worried/anxious’.
Please generate a short, empathetic message that acknowledges the user's feelings and offers one or two concrete suggestions.”

In another example, the server may generate a prompt sentence such as:
“Please estimate the user's emotion from the following utterance and then generate one paragraph of encouragement or advice in English that is empathetic and practical.
User utterance: ‘Recently, my work hasn't been going well and I'm really worried.’”

In yet another example, the server may generate a multi-step instruction prompt sentence such as:
“First, infer the user's emotional state from the following sentence.
Second, write a brief message that both reflects that emotion and gives specific, constructive advice.
Sentence: ‘Recently, my work hasn't been going well and I'm really worried.’
Output only the final message to the user.”

By constructing prompt sentences in this structured and parameterized manner, the server modifies the internal operation of the generative information processing model. The server configures the model's behavior by conveying to the model not only the user's text but also explicit emotion labels, requested response style, response length, and the intended content structure. This use of structured emotion metadata and template-based prompt generation yields a technical improvement: it constrains the search space of the generative model, increases the probability of generating an appropriate response on the first attempt, and thereby reduces computational load, latency, and bandwidth usage associated with retries or auxiliary filtering.

The server inputs the generated prompt sentence to the generative information processing model and causes generation of response information including encouragement or advice corresponding to the emotional state. In one embodiment, the generative information processing model is a neural network-based language generation model, such as a transformer decoder, trained on large-scale text data. The server represents the prompt sentence as a sequence of tokens, computes embeddings, and feeds the embeddings into the model. The model applies multiple layers of self-attention and feedforward transformations to predict a probability distribution over the next token at each generation step. The server uses decoding strategies such as greedy decoding, beam search, top-k sampling, or nucleus sampling to generate output tokens until an end-of-sequence token or a predefined length limit is reached. The server then converts the tokens back to text to obtain the response information.

The server can configure parameters of the generative information processing model, such as maximum token length, temperature, and sampling policy, based on the structured information and interaction history. The server may, for example, set a lower temperature and shorter maximum length for users who prefer concise advice, as determined from past responses, and a higher temperature and more expansive output for users who respond favorably to more exploratory discussions. By linking these parameters to the structured information and interaction history, the server systematically modifies the internal state evolution and output distribution of the generative model, thereby improving consistency, efficiency, and personalization beyond simple static prompts.

The server transmits the response information back to the terminal via the communication interface. The response information may include not only the generated text but also metadata such as the emotion category used for generation, the generation parameters, and a timestamp. The server may apply post-processing, such as removing unintended artifacts, enforcing content safety rules, and truncating excessively long responses. These post-processing rules can be implemented as deterministic filters or as additional classifier-based checks. This pipeline enables technical control over model output at multiple levels, reducing the burden on terminal-side processing and providing more predictable network traffic patterns.

The terminal receives the response information and presents it to the user. The terminal displays the text on a display device using a graphical user interface framework. The terminal may arrange the text in a chat-like bubble, highlight key phrases, and optionally show an indicator of the detected emotion, such as “Detected emotion: worried,” in a non-intrusive manner. The terminal can store the displayed messages and associated metadata in a local database or cache for offline viewing, thereby reducing the need to re-request past data from the server.

The terminal may also convert the response information into an audio signal using a text-to-speech module. The terminal sends the text to a text-to-speech engine, which analyzes the text, determines prosodic features such as pitch and duration, and synthesizes an audio waveform. The terminal then outputs the synthesized waveform through the voice output device. The terminal may adjust the output volume or speaking rate based on user preferences or accessibility settings. By using device-local text-to-speech, the system leverages hardware acceleration on the terminal side and reduces round-trip latency that would be incurred if all audio synthesis were performed on the server.

The server can maintain an interaction history for each user or session. The server stores, in a database, records including at least the user utterance text, the estimated emotion category and confidence degree, the prompt sentences used, the response information generated, and timestamps. The server may use this history to infer long-term patterns, such as recurring emotional categories or topics. The server then adjusts future prompt sentences automatically based on these patterns. For example, if the interaction history indicates frequent worry related to work, the server can modify prompt sentences to explicitly instruct the generative model to avoid repetitive content and to prioritize new coping strategies. By encoding and reusing this historical information, the server reduces redundant computation and improves the precision of model control.

In another embodiment, the server implements multiple emotion classification models or multiple generative models and selects among them based on system-level optimization. The server may select a lightweight emotion classifier for short, low-complexity utterances and a more sophisticated classifier for longer or ambiguous utterances. Similarly, the server may use a smaller generative model for quick, low-latency responses and a larger model for more detailed counseling when network conditions and server load permit. This model selection is driven by structured information and system state, not merely by user preference, and thereby improves the overall computational efficiency and scalability of the system.

The server trains the neural network models, such as the emotion classification model and the generative information processing model, using supervised learning, unsupervised learning, or a combination thereof. For the emotion classification model, the server uses a training dataset where each text sample is labeled with one or more emotion categories. The server defines a loss function, such as cross-entropy loss, between the predicted category distribution and the ground-truth labels. The server updates the model parameters using an optimization algorithm, such as stochastic gradient descent or an adaptive gradient method. The server may apply data augmentation techniques, such as synonym replacement, paraphrasing, or noise injection, to increase robustness. For the generative model, the server trains the model to predict the next token in a sequence given previous tokens, possibly with additional conditioning on emotion labels or style tags. The server may fine-tune a pre-trained language model on a corpus of emotionally annotated dialogues, minimizing a language modeling loss function. By describing these learning procedures, the system provides concrete techniques for obtaining models that can reliably process emotional text in a computationally efficient manner.

The server benefits from the described architecture by achieving technical improvements over conventional systems. Because the server converts audio to text, then text to structured emotion metadata, and then uses that metadata to deterministically construct prompt sentences, the server reduces ambiguity in how a generative AI model is instructed. This deterministic control reduces the number of invalid or irrelevant responses generated, which in turn reduces the number of required regeneration cycles and the volume of network traffic needed to correct outputs. The server also decreases latency because it avoids performing ad hoc heuristic filtering on long generated texts. The combination of a structured emotion representation, template-based prompt construction, and adjustable generation parameters yields a more efficient use of computational resources, and this efficiency is realized through specific data structures and algorithmic flows inside the computer system.

In particular, the system does not merely automate a human counselor's task. A human counselor typically interprets emotional content qualitatively and generates advice using human reasoning, without explicit numerical confidence degrees or structured prompts controlling an underlying generative model. In contrast, the server operates under defined rules: it generates numerical emotion scores, stores them in programmatically accessible structures, and uses them to configure the behavior of a generative model through prompt sentences and generation parameters. This processing is tailored to the capabilities and limitations of machine learning models, and thereby improves the operation of the computing system itself. The cause-and-effect relationship between the structured emotion representation and improved generative behavior is explicit: by narrowing the output space with emotionally informed instructions and parameters, the server reduces both computational cost and error rates.

Various modifications and alternative embodiments are possible. The server may use different network architectures for the emotion classification model, such as a bidirectional recurrent neural network with attention, a convolutional neural network over character-level input, or a transformer-based encoder-decoder model. The server may represent structured information using different data structures, such as key-value maps, relational tables, or graph representations. The terminal may be a smartphone, a tablet, a personal computer, a dedicated counseling device, or an embedded system in a vehicle or appliance. The communication network may be a cellular network, a wireless local area network, a wired network, or any combination thereof. The generative information processing model may be hosted on the same physical server as the emotion classification model or on a different computing apparatus accessed via an application programming interface.

In all such variations, the server, terminal, and user cooperate in a manner that realizes the claimed technical features: the terminal captures and transmits digital audio information; the server executes speech recognition, natural language processing, structured emotion estimation, and controlled prompt sentence generation; the server drives a generative AI model in a technically constrained way to produce encouragement or advice; and the terminal presents the result to the user through specific hardware devices. This arrangement enables other skilled persons to implement the invention concretely, while maintaining the technical improvements in processing speed, accuracy, data management, and computational efficiency that distinguish the system from conventional abstract or purely manual approaches.

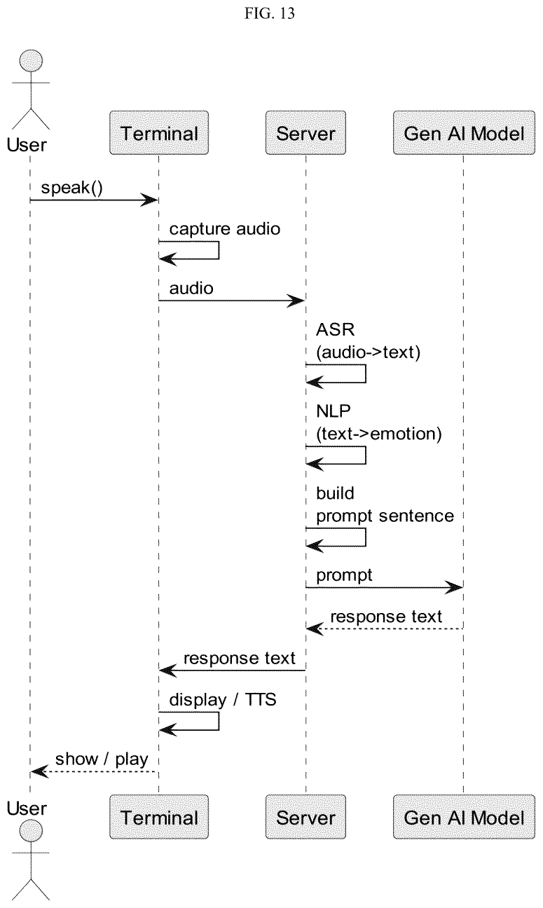

The following describes the processing flow using FIG. 13.

### Step 1

The user provides a spoken utterance to the system.
The user directs speech toward the terminal's microphone and, for example, says: “Recently, my work hasn't been going well and I'm really worried.”
Input: No machine-readable input; the input is the user's analog voice.
Output: The output is an analog audio signal in the physical world, which becomes the source for digital acquisition by the terminal.

### Step 2

The terminal acquires the analog audio signal and converts it into digital audio information.
The terminal uses an audio capture interface of an operating system to sample the analog signal at a fixed sampling rate (for example, 16 kHz) and quantizes the samples into 16-bit PCM data. The terminal stores the samples in an audio buffer in memory and may perform noise reduction, echo cancellation, and voice activity detection to remove background noise and extract voice segments.
Input: The input is the analog audio signal from the user's speech.
Output: The output is digital audio information, such as a sequence of PCM frames or an audio file in a standardized format.

### Step 3

The terminal prepares and transmits the digital audio information to the server.
The terminal packages the digital audio information and metadata, such as sampling rate, encoding type, and language code, into a request message. The terminal uses a communication interface to send the message to the server over a network using a secure application protocol.
Input: The input is the digital audio information stored in the terminal's buffer and related metadata.
Output: The output is a network request containing the digital audio information and metadata, which is transmitted to the server.

### Step 4

The server receives and normalizes the digital audio information.
The server reads the request, extracts the digital audio data, and checks the audio format. The server uses an audio processing library to resample or re-encode the audio as necessary to match a recognition engine's expected format, for example converting stereo to mono and enforcing a specific sampling rate.
Input: The input is the digital audio information and metadata received from the terminal.
Output: The output is normalized digital audio information in a consistent internal format ready for speech recognition.

### Step 5

The server executes a speech recognition process to convert the normalized digital audio information into character information.
The server computes acoustic features, such as Mel-frequency cepstral coefficients or log Mel-spectrograms, from the normalized audio frames. The server feeds the acoustic features into an acoustic model and applies decoding with a language model to determine the most likely sequence of words. The server then outputs a text string representing the user's utterance.
Input: The input is the normalized digital audio information.
Output: The output is character information, such as a Unicode text string: “Recently, my work hasn't been going well and I'm really worried.”

### Step 6

The server preprocesses the character information for natural language processing.
The server applies normalization operations, such as lowercasing, whitespace normalization, and removal of redundant punctuation. The server tokenizes the text into tokens or sub-word units, using a tokenizer corresponding to a neural language model.
Input: The input is the raw character information obtained from speech recognition.
Output: The output is normalized character information and a token sequence representation suitable for further analysis.

### Step 7

The server estimates the user's emotional state by executing natural language processing on the tokenized text.
The server maps each token to a numerical identifier, generates embedding vectors, and feeds the sequence of embeddings into an emotion classification model, such as a transformer-based neural network. The server calculates a probability distribution over emotion categories, such as “worried,” “sad,” “happy,” and “neutral,” and determines the emotion category with the highest probability as the user's emotional state. The server also records the associated confidence degree.
Input: The input is the tokenized and normalized character information.
Output: The output is structured information including at least an emotion category (for example, “worried”) and a confidence degree (for example, 0.87).

### Step 8

The server constructs a prompt sentence for a generative AI model based on the character information and the structured emotional information.
The server selects a template according to the emotion category and confidence degree and fills placeholders in the template with the user's utterance and the estimated emotional state.
The server may also include instructions about style, length, and content. For example, the server may generate a prompt sentence:
“You are an assistant that provides emotional support.
The user utterance is: ‘Recently, my work hasn't been going well and I'm really worried.’
The estimated emotion is: ‘worried/anxious’.
Please generate a short, empathetic message that acknowledges the user's feelings and offers one or two concrete suggestions.”
Input: The input is the character information and the structured information including the emotion category and confidence degree.
Output: The output is a prompt sentence in text form, specifically structured for the generative AI model.

### Step 9

The server adjusts generation parameters for the generative AI model using the structured emotional information and interaction history.
The server retrieves, from a database, records of prior interactions for the same user, such as previous emotions and response preferences. The server computes values for parameters, such as maximum token length, temperature, and desired level of concreteness, based on the emotion category and historical patterns. The server then associates these parameter values with the current prompt sentence.
Input: The input is the structured emotional information and the interaction history associated with the user.
Output: The output is a parameter set, including values for generation controls that will be used together with the prompt sentence.

### Step 10

The server inputs the prompt sentence and the parameter set to the generative AI model to generate response information.
The server tokenizes the prompt sentence, maps tokens to embeddings, and feeds them into the generative AI model, such as a transformer-based language generation model. The server configures the decoding process using the parameter set, for example by setting temperature and maximum length. The model calculates probability distributions over possible next tokens at each step, and the server selects tokens according to the decoding strategy until a termination condition is met. The server then concatenates the tokens to obtain the generated text.
Input: The input is the prompt sentence and the generation parameter set.
Output: The output is response information in text form, for example an empathetic message that includes encouragement or advice tailored to the “worried” emotion.

### Step 11

The server post-processes the response information and prepares it for transmission to the terminal.
The server trims leading and trailing whitespace, checks for disallowed or irrelevant content using rule-based filters or classifier outputs, and, if necessary, truncates overly long segments to a permitted length. The server then packages the cleaned response text and associated metadata, such as the emotion category and timestamp, into a response message.
Input: The input is the raw response information generated by the generative AI model.
Output: The output is a formatted response message suitable for network transmission, containing the finalized response text and metadata.

### Step 12

The server transmits the formatted response message to the terminal via the communication interface.
The server uses a network protocol stack to send the response as a message, such as an HTTP response, to the terminal's network address. The server may compress the payload or apply encryption, depending on configuration, to reduce bandwidth usage and protect privacy.
Input: The input is the formatted response message created in the server's memory.
Output: The output is a network transmission carrying the response message to the terminal.

### Step 13

The terminal receives the response message and extracts the response information.
The terminal's communication device reads the incoming data stream, reassembles the response message, and passes it to an application layer. The terminal parses the message to obtain the response text and any metadata, such as the emotion label or timestamp.
Input: The input is the network transmission from the server containing the response message.
Output: The output is structured data within the terminal, including the response text and metadata fields.

### Step 14

The terminal presents the response information to the user via a display device.
The terminal creates user interface elements, such as text areas or dialog bubbles, and populates them with the response text. The terminal may indicate the detected emotion in a label or icon, for example “Detected emotion: worried.” The terminal updates the screen so that the user can read the generated encouragement or advice.
Input: The input is the response text and associated metadata stored in the terminal's memory.
Output: The output is a visual rendering of the response information on the display device.

### Step 15

The terminal optionally converts the response information into an audio signal and outputs it via a voice output device.
The terminal sends the response text to a text-to-speech engine, which analyzes the text, determines phonetic and prosodic characteristics, and synthesizes an audio waveform. The terminal plays the waveform through the speaker or headphone, allowing the user to listen to the generated message.
Input: The input is the response text obtained from the server.
Output: The output is a synthesized audio signal output by the voice output device, corresponding to the response information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional conversational systems that provide encouragement or advice based on user input typically rely on static rules or single-shot sentiment analysis. Such systems suffer from several technical deficiencies. First, conventional systems do not maintain a time-series model of user emotional states; as a result, the systems cannot detect significant changes or trends in emotion (for example, a gradual increase in fear or stress). This limitation causes the systems to generate responses that are insensitive to evolving user context, which leads to low relevance and low effectiveness of generated messages.

Second, conventional systems that invoke a generative AI model generally construct input prompts in a fixed or ad-hoc manner. Because the systems do not systematically reflect structured emotion data, such as emotion type, intensity, and occurrence time, in the prompt, the generative AI model receives incomplete contextual information. This often produces generic or mismatched output, which degrades the technical performance of the overall pipeline, including wasted computation on the model side and increased need for post-processing or manual intervention.

Third, conventional architectures typically treat abnormal emotional states, such as extreme fear, anger, or anxiety, as ordinary input. They do not provide a built-in mechanism to detect an abnormal emotional state and trigger a separate control flow, such as real-time notification to a monitoring device and parallel generation of a calming response to the user. Consequently, system resources are not allocated according to urgency, and the latency and reliability of alerting functions in high-risk environments, such as security checkpoints or monitored facilities, remain inadequate.

Fourth, prior systems generally do not adjust the expression format, writing style, and level of detail of the generative AI model input according to computed stress or anxiety tendencies. From a computer-technology perspective, this means that the prompt construction subsystem is not optimized with respect to the underlying emotional profile, causing suboptimal conditioning of the generative AI model and limiting the ability of the system to produce stable, context-appropriate outputs across heterogeneous users and usage scenarios.

Accordingly, there is a need for improved computer technology that (i) acquires user voice or character information, (ii) converts and analyzes the information to estimate an emotional state, (iii) records the emotional state in time series, (iv) detects emotion changes and abnormal emotional states, and (v) dynamically constructs and adjusts prompt sentences for a generative AI model based on structured emotional data. Such technology should also be able to trigger real-time warning information to a monitoring information processing device while, in parallel, generating and presenting encouragement or advice to the user, thereby improving system-level responsiveness, robustness, and effectiveness of AI-generated communication.

The specific processing by the specific processing unit 290 of the data processing device 12 in Application Example 2 is realized by the following means.

The present invention provides a server comprising a processor configured to acquire user voice information or character information via an input device, convert acquired voice information into character information by using a speech recognition technique, analyze the character information by using a natural language processing technique to estimate a user emotional state, generate, on the basis of the estimated emotional state and the character information, a prompt sentence that is an instruction sentence to be input to a generative AI model, input the generated prompt sentence to the generative AI model to cause the generative AI model to generate response information including encouragement or advice corresponding to the emotional state, record the estimated emotional state in time series as structured data including an emotion type, an intensity, and an occurrence time, compare a past emotional state with a current emotional state to identify a change in emotion, dynamically change contents, expression format, writing style, and level of detail of the prompt sentence in accordance with the identified emotional state, the change in emotion, and a calculated stress tendency or anxiety tendency of the user, and, when the identified emotional state or the change in emotion is determined to be an abnormal state exceeding a predetermined criterion, transmit warning information including identification information regarding the user and a summary of the emotional state to a monitoring information processing device while, in parallel, providing to the user, via an output device, the response information including encouragement or advice for providing a sense of security generated by the generative AI model. This enables the computer system to technically improve acquisition, modeling, and utilization of user emotional states by maintaining a time-series emotional context, by optimizing prompt sentences supplied to the generative AI model based on structured emotional data, and by dynamically branching processing to both real-time alert transmission and context-appropriate response generation, thereby enhancing computational efficiency, responsiveness, robustness, and relevance of AI-mediated interactions compared to conventional systems.

The term “user voice information” refers to audio data representing spoken utterances of a user that is captured by an input device such as a microphone and processed as digital signal data by the system.

The term “character information” refers to textual data expressing content input by a user or generated by the system, including text obtained by transcription of voice information or by direct keyboard or touch input.

The term “input device” refers to a hardware or software interface configured to acquire information from a user, including but not limited to a microphone, a keyboard, a touch panel, or a graphical user interface element that accepts text input.

The term “output device” refers to a hardware or software interface configured to present information to a user, including but not limited to a display, a speaker, or a graphical user interface component that renders text or audio.

The term “speech recognition technique” refers to a computational process that converts digital audio data representing human speech into corresponding character information by analyzing acoustic features and language patterns.

The term “natural language processing technique” refers to a computational process that analyzes character information to determine linguistic structure and semantic content, including at least one of tokenization, part-of-speech tagging, syntactic parsing, and semantic or sentiment analysis.

The term “user emotional state” refers to an internal psychological condition of a user inferred by the system from user voice information or character information, including at least one of emotion type, intensity, polarity, and associated contextual attributes.

The term “generative AI model” refers to an artificial intelligence model that receives a text input and generates new text output according to learned statistical or neural network parameters, the model being capable of producing encouragement or advice messages conditioned on a prompt sentence.

The term “prompt sentence” refers to a text string that functions as an instruction sentence to be input to the generative AI model, the text string specifying at least part of the context, desired tone, and content constraints for the text to be generated.

The term “response information” refers to text or audio output generated directly or indirectly by the generative AI model, the output including at least encouragement or advice that corresponds to the user emotional state.

The term “time series” refers to an ordered sequence of data records associated with respective times of occurrence, including ordered records of user emotional states stored with timestamps by the system.

The term “structured data” refers to data organized into a predefined format with explicit fields, such as emotion type, intensity, and occurrence time, that can be stored, queried, and processed by the system.

The term “change in emotion” refers to a difference between at least two user emotional states determined at different times, including changes in emotion type, intensity, or both, as identified by comparing time-series emotional data.

The term “stress tendency” refers to a measure computed by the system that indicates a propensity of a user to experience stress over a period of time, the measure being derived from accumulated structured data of emotional states.

The term “anxiety tendency” refers to a measure computed by the system that indicates a propensity of a user to experience anxiety over a period of time, the measure being derived from accumulated structured data of emotional states.

The term “abnormal state” refers to a user emotional state or a change in emotion that exceeds a predetermined criterion or threshold, the state being considered atypical or of heightened concern in a monitored context.

The term “predetermined criterion” refers to a threshold or condition defined in advance by configuration or program logic, against which the system compares values related to user emotional state or change in emotion to determine whether an abnormal state exists.

The term “monitoring information processing device” refers to an information processing apparatus, separate from a user terminal, that receives warning information and is operated by a monitoring person or system responsible for supervision or intervention.

The term “warning information” refers to data transmitted from the server to the monitoring information processing device, the data including at least identification information of a user and a summary of a corresponding emotional state or abnormal state.

The term “identification information” refers to data that enables association of an emotional state or response with a particular user or session, including at least one of a user identifier, a device identifier, a session identifier, or location information.

The term “expression format of the prompt sentence” refers to structural aspects of the prompt sentence, including at least sentence length, segmentation into instructions, inclusion of labels or metadata, and use of additional contextual descriptions.

The term “writing style of the prompt sentence” refers to stylistic characteristics of the prompt sentence, including at least politeness level, formality, tone, and narrative perspective, that condition the generative AI model's output style.

The term “level of detail of contents of the prompt sentence” refers to a degree to which the prompt sentence includes specific contextual information, constraints, and examples, ranging from concise instructions to rich multi-sentence descriptions.

In one embodiment, a system includes a server, at least one terminal, one or more input devices, and one or more output devices. The server includes at least one processor and at least one memory storing programs and data structures. The terminal includes at least one processor, a microphone, a display, a speaker, and an interface for transmitting and receiving data with the server over a communication network.

The terminal acquires user voice information via the microphone and converts the analog signal into digital audio samples. The terminal stores the audio samples in a buffer in memory and transmits the buffered audio to the server using a network protocol such as HTTPS. Alternatively, the user inputs character information directly via a keyboard or touchscreen, and the terminal transmits this character information as text to the server.

The server receives the audio or text and normalizes all input into character information. In one example, the server uses a speech recognition software component corresponding to a generic cloud speech-to-text service to convert digital audio into text. The server supplies the audio waveform, an encoding format (for example, linear PCM), and a sampling rate to the speech recognition engine and receives a transcription as character information. The server stores the transcription together with a timestamp and a user identifier in a data store.

The server performs natural language processing on the character information by using a language processing library, such as a statistical or neural-network-based tokenizer, part-of-speech tagger, and syntactic parser. The server converts the text into a token sequence, generates part-of-speech tags, identifies dependency relations, and constructs a vector representation of the text. The server in one embodiment uses word embeddings and sentence embeddings, which are numeric feature vectors representing the semantic content of the utterance.

The server estimates a user emotional state based on the processed text and, optionally, acoustic features. In one embodiment, the server extracts prosodic features from the audio, such as average pitch, pitch variance, speaking rate, and energy. The server concatenates textual embeddings and acoustic features into a joint feature vector and inputs this vector to an emotion classification model implemented as a multi-layer neural network. The neural network in one example has an input layer receiving the feature vector, one or more hidden layers with non-linear activation functions such as rectified linear units, and an output layer producing a probability distribution over emotion categories such as sadness, joy, anger, fear, tension, and fatigue.

The server trains the emotion classification neural network in advance using supervised learning. The server uses a collection of training examples consisting of text and audio pairs labeled with ground-truth emotions. The server calculates an error using a loss function such as cross-entropy between predicted probabilities and true labels, and updates network weights by gradient-based optimization such as stochastic gradient descent or an adaptive method. The server optionally performs data augmentation on the training set by adding noise to audio, altering pitch, or paraphrasing text so that the classifier becomes robust to real-world variations. This training procedure results in a model that can recognize emotional states more accurately than rule-based methods.

The server represents each estimated emotional state as structured data including at least an emotion type, an intensity value, and an occurrence time. The server stores each structured record in a time-series data structure, such as an array or table indexed by user identifier and timestamp. The server also maintains rolling statistics, such as an average intensity for each emotion type over several recent entries, and a derivative or difference between current and past intensity values. This design allows the server to compare a past emotional state with a current emotional state and identify a change in emotion, including both abrupt shifts and gradual trends.

The server computes a stress tendency and an anxiety tendency of the user from the stored structured emotional records. The server, for example, calculates a weighted sum or an exponentially weighted moving average of intensities for stress-related emotions over a predetermined time window. The server updates these tendencies incrementally when new emotional states are recorded, which reduces computation compared with reprocessing the entire history and therefore improves processing speed and resource usage.

The server constructs a prompt sentence to be input to a generative AI model on the basis of the character information and the current and historical emotional state data. The server includes, in the prompt sentence, explicit labels describing the emotion type, intensity, and context. In one example, when the user writes “Recently, I've been making a lot of mistakes at work and feel depressed,” and the system detects a depressed emotional state, the server generates a prompt sentence such as:

“The user wrote: ‘Recently, I've been making a lot of mistakes at work and feel depressed.’ The detected emotion is depression with high intensity in a work context. Please generate a short, warm, and encouraging message that acknowledges the user's feelings, avoids judgment, and offers hopeful and practical advice.”

The server adjusts the expression format, writing style, and level of detail of the prompt sentence according to the stress tendency and anxiety tendency of the user. When the server detects a high stress tendency, the server increases the level of detail, explicitly instructing the generative AI model to avoid complex advice and to use simple, reassuring language. When the server detects a low stress tendency, the server may permit a more neutral or informational style. This dynamic adjustment of prompt composition conditions the generative AI model in a way that is not achievable with fixed prompts and produces more stable and context-appropriate outputs.

The server provides the prompt sentence as input to a generative AI model. In one embodiment, the generative AI model is a neural text generation model implemented as a transformer architecture. The model includes multiple layers of self-attention and feed-forward networks and is trained on large corpora of text with an autoregressive objective. The model receives the prompt sentence token sequence and successively predicts subsequent tokens to generate response information in text form.

The server configures generation parameters for the generative AI model, such as a maximum output length, a sampling temperature, and a nucleus sampling parameter. The server can adjust these parameters based on the emotion state; for example, the server uses a lower temperature and shorter length for highly distressed users to avoid unexpected or overly complex responses. This parameter adaptation, combined with emotional state-aware prompt design, improves both the robustness and the computational efficiency of the generation process by reducing unnecessary token generation and lowering the risk of irrelevant outputs.

The server performs a safety or content filter on the generated response information. In one embodiment, the server uses a secondary classifier trained to detect undesirable content such as insults or dangerous advice and, if detected, regenerates the response with modified constraints in the prompt sentence. This process further refines the technical pipeline and ensures that the system produces reliable and safe outputs.

The server sends the final response information to the terminal. The terminal displays the text on a graphical user interface and, if configured, converts the text to voice using a text-to-speech engine. The text-to-speech engine transforms the text into an audio waveform that the terminal outputs through the speaker. By integrating display and audio output, the system adapts to different user environments and improves usability in noisy or hands-free scenarios.

The server records each generated response together with the corresponding emotional state and prompt sentence in storage. This logging enables offline analysis and model retraining, whereby the server can periodically refine both the emotion classifier and the prompt generation strategy. By continuously updating the models with new data, the system improves emotion detection accuracy and the quality of generated advice over time.

The server also detects abnormal emotional states based on the time-series emotional data. When the server determines that a user emotional state or a change in emotion exceeds a predetermined criterion, for example, a fear intensity above a high threshold or a rapid increase in anger, the server generates warning information. The warning information includes at least user identification information and a summary of the emotional state. The server transmits this warning information to a monitoring information processing device operated by a human supervisor or an automated monitoring system.

The server, in parallel with transmitting the warning information, generates a prompt sentence instructing the generative AI model to produce a calming message for the user. For instance, when the user says “I'm scared of getting on the plane” in a monitored area, and the fear emotion is both intense and above a threshold, the server generates a prompt sentence such as: “The user said: ‘I'm scared of getting on the plane.’ The detected emotion is fear at a high level in an airport security context. Please generate a short, calm, and reassuring message that validates the fear and gently encourages the user, without minimizing their feelings.”

The server sends this prompt sentence to the generative AI model and obtains a response such as “It is understandable to feel nervous before a flight. Take slow, deep breaths and remember that many safety measures are in place to protect you.” The terminal then presents this response to the user while the monitoring information processing device receives a real-time alert. This split processing path allows the system to simultaneously support the user and inform security personnel, improving safety response times and reducing the need for constant manual monitoring of all interactions.

The described configuration improves computer technology beyond mere automation of human judgment. The server uses specific data structures for time-series emotional states and structured emotion records and exploits these data structures to compute trends and tendencies incrementally, which reduces memory access and computation compared with naïve recomputation. The server also performs non-conventional prompt construction by injecting structured emotional parameters and dynamically adjusting style and detail. This produces more efficient use of generative AI computation because the generative AI model is less likely to generate off-topic or unusable text, thereby saving processing cycles and network bandwidth.

The system increases accuracy of emotional state estimation by combining natural language features and acoustic features in a neural classifier and by training the classifier with data augmentation and explicit loss minimization. The system reduces error in detecting abnormal states by using thresholding on both instantaneous emotion intensity and temporal derivatives. As a result, the server can prioritize processing and communication resources for high-risk cases and avoid over-alerting, thus improving both detection precision and overall computational efficiency.

The system improves data management by storing emotional records in structured form with indices for user and time, allowing efficient retrieval for trend analysis and prompt adaptation. The server can query recent records for a given user without scanning the entire database. This structure supports real-time operation in high-traffic environments such as security checkpoints or customer support centers.

The system also applies non-conventional rules and procedures in constructing prompt sentences. Instead of simply forwarding user text to a generative AI model, the server integrates quantitative emotional metrics, stress tendencies, and context tags into the prompt sentence and modifies sentence structure and verbosity. This process is tailored to the generative AI model's conditioning behavior and leads to observable improvements in the stability and relevance of generated content.

Alternative embodiments are possible. The terminal may perform some or all of the speech recognition and emotion classification locally, sending only intermediate representations or structured emotion data to the server. This reduces network load and protects privacy by avoiding transmission of raw audio. The server may host multiple generative AI models of different sizes and select a model based on available computation resources or urgency; for low-risk, low-stress cases, the server may select a smaller, faster model, and for high-risk, high-stress cases, the server may select a larger, more accurate model.

The server may also employ different neural network architectures for emotion classification, such as recurrent neural networks or convolutional neural networks applied to spectrograms. The server may use different loss functions, such as mean-squared error for intensity regression, or multi-task learning where emotion type and intensity are predicted jointly. The server may tune decision thresholds for abnormal state detection according to the application domain, for example, stricter thresholds in aviation security versus more relaxed thresholds in general wellness applications.

In each of these embodiments, the server, the terminal, and the user interact through specifically defined hardware and software components, and the described processing pipeline improves the functioning of the computer system itself. The combination of structured time-series emotional modeling, dynamic prompt sentence construction, and selective alert and response generation provides technical effects such as improved emotion detection accuracy, more efficient use of generative AI resources, faster and more reliable alerting in critical contexts, and reduced computational and communication overhead compared with conventional, static or rule-based conversational systems.

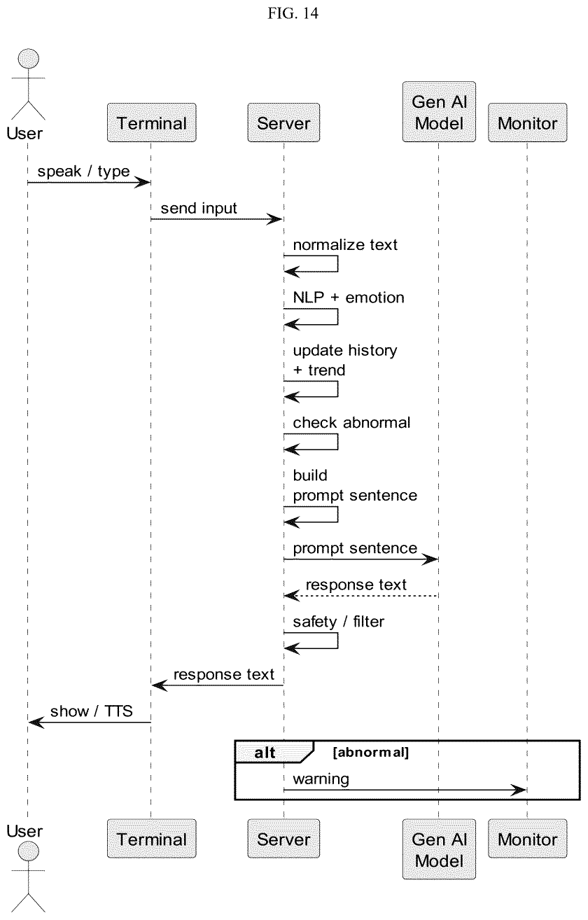

The following describes the processing flow using FIG. 14.

### Step 1

The user provides an utterance or text input to the system.
The user speaks a sentence, such as “Recently, I've been making a lot of mistakes at work and feel depressed,” into a microphone of the terminal or types an equivalent sentence on a keyboard or touch screen.
The input is analog voice or typed characters, and the output is digital audio data or a character string stored in the terminal's memory. The terminal samples the analog voice signal, converts it to digital samples, buffers the samples, or directly stores typed characters in a text buffer.

### Step 2

The terminal transmits the input data to the server.
The terminal packages the buffered digital audio data or the character string into a request message including at least a user identifier, a session identifier, and a timestamp, and sends the request to the server via a network protocol such as HTTPS.
The input is the buffered audio or text and associated metadata, and the output is a network packet stream delivered to the server. The terminal may compress the audio, attach format information (encoding, sampling rate, language code), and open a secure socket connection to reduce transmission time and protect data.

### Step 3

The server normalizes the user input into character information.
The server inspects the received request to determine whether the payload is audio data or a text string. When the payload is audio, the server calls a speech recognition engine, supplies the audio waveform, encoding format, and language code, and obtains a transcription. When the payload is already text, the server passes it through unchanged.
The input is the raw audio or text payload and metadata, and the output is normalized character information representing the user's utterance. The server stores the character information together with the user identifier and timestamp in a data store.

### Step 4

The server performs natural language preprocessing on the character information.
The server applies a natural language processing library to the character information, performs tokenization, part-of-speech tagging, and syntactic parsing, and generates numeric feature representations such as word embeddings or sentence embeddings.
The input is the character information (plain text), and the output is a set of processed structures including a token sequence, linguistic tags, and one or more feature vectors. The server computes these outputs by mapping each token to an embedding vector, aggregating vectors (for example, by averaging or using an encoder network), and packaging the data in a feature object.

### Step 5

The server optionally extracts acoustic features from the audio data.
When audio data is available, the server retrieves the stored audio and calculates prosodic features such as average fundamental frequency, pitch variance, speaking rate, and frame-level energy. The server may also compute spectral features such as Mel-frequency cepstral coefficients.
The input is the digital audio waveform corresponding to the utterance, and the output is a numerical feature vector representing acoustic characteristics. The server performs data processing such as framing the audio, applying window functions, computing Fourier transforms, and aggregating statistics over time.

### Step 6

The server estimates the user emotional state.
The server concatenates the textual feature vector and the acoustic feature vector (if present) to form a joint feature vector and inputs this vector to a trained neural network-based emotion classifier. The classifier outputs probabilities for emotion classes such as sadness, joy, anger, fear, tension, and fatigue, and estimated intensity values.
The input is the joint feature vector, and the output is structured emotion data including an emotion label, intensity, and confidence score. The server computes this output by performing matrix multiplications and non-linear activations in each layer of the neural network and applying a softmax or similar function in the output layer.

### Step 7

The server records the emotional state in a time-series data structure.
The server creates a record containing the user identifier, the emotion label, the intensity value, the confidence score, and the occurrence time, and stores this record in a time-ordered table or database. The server may index the record by user identifier and timestamp.
The input is the structured emotion data and the current timestamp, and the output is an updated time-series data structure that includes the new record. The server updates summary statistics, such as moving averages of intensities, by combining the new record with existing aggregate values.

### Step 8

The server computes emotional trends, including stress tendency and anxiety tendency.
The server retrieves a plurality of recent emotion records for the same user from the time-series store and calculates metrics such as an exponentially weighted moving average of negative emotions and a rate of change of fear or tension intensities. The server updates internal variables representing stress tendency and anxiety tendency.
The input is a set of historical emotion records for the user, and the output is one or more numeric indicators representing emotional tendencies. The server performs data operations such as weighted summation, normalization, and difference calculation over the retrieved records.

### Step 9

The server determines whether an abnormal emotional state or abnormal change in emotion has occurred.
The server compares the current emotional state and the computed tendencies against predetermined thresholds and criteria. For example, the server checks whether fear intensity exceeds a first threshold or whether the increase in anger over a short period exceeds a second threshold. The server sets a flag when these conditions are met.
The input is the current emotion record, the trend indicators, and the predetermined criteria, and the output is a decision result indicating normal or abnormal state and, optionally, the type of abnormality. The server performs logical comparisons and rule evaluation to obtain this result.

### Step 10

The server constructs a prompt sentence for the generative AI model.
The server assembles a text string that includes the user's original character information, the detected emotion type and intensity, and relevant context such as location or role. The server selects a template based on stress tendency and anxiety tendency and fills the template with the actual values. For high stress, the server chooses more explicit and gentle wording; for lower stress, the server may choose a more neutral style.
The input is the character information, the structured emotion data, and the emotional tendency indicators, and the output is a prompt sentence suitable for conditioning the generative AI model. The server generates the prompt sentence by concatenating static template phrases and dynamic elements and by inserting constraints on tone, length, and content. An example output is: “The user wrote: ‘Recently, I've been making a lot of mistakes at work and feel depressed.’ The detected emotion is depression with high intensity in a work context. Please generate a short, warm, and encouraging message that acknowledges the user's feelings, avoids judgment, and offers hopeful and practical advice.”

### Step 11

The server adjusts the format, style, and level of detail of the prompt sentence.
The server modifies the prompt sentence by altering sentence length, adding or removing explanatory sentences, and specifying desired style attributes such as “polite,” “simple language,” or “professional tone,” depending on stress tendency and anxiety tendency values.
The input is the initial prompt sentence and the emotional tendency indicators, and the output is a refined prompt sentence with updated structure and instructions. The server obtains this output by applying formatting rules, such as adding style descriptors for high anxiety (e.g., “use calm and reassuring language”), and by truncating or expanding the context text.

### Step 12

The server provides the prompt sentence to the generative AI model and generates response information.
The server tokenizes the prompt sentence, encodes it as input tokens, and sends the token sequence and generation parameters (such as maximum token count and sampling temperature) to a neural generative AI model, for example, a transformer-based language model. The model processes the tokens layer by layer and predicts subsequent tokens to form a response text.
The input is the tokenized prompt sentence and generation parameters, and the output is a generated text response that includes encouragement or advice tailored to the emotional state. The server decodes the model's token outputs back into character information and optionally removes leading or trailing control tokens.

### Step 13

The server performs safety and relevance checks on the generated response.
The server applies a secondary classifier or rule set to the generated text to detect prohibited content, overly complex language, or responses that do not fit the specified emotional context. When a problem is detected, the server either rejects the response or regenerates it with additional constraints inserted into a revised prompt sentence.
The input is the generated response text and predefined safety and relevance criteria, and the output is an approved response text ready for delivery to the user. The server executes pattern matching, classification, or keyword filtering to implement these checks.

### Step 14

The server determines whether to send warning information to a monitoring information processing device.
When the decision result from abnormality determination indicates an abnormal state, the server constructs a warning message that includes the user identifier, the estimated emotional state, and a summary of the detected abnormal condition. The server then transmits this warning message to a monitoring device via a network interface.
The input is the abnormality decision result, the structured emotion data, and the user identification information, and the output is a network message carrying warning information to the monitoring device. The server converts the structured data into a message format and sends it using a communication protocol such as HTTPS or a message-queue system.

### Step 15

The server transmits the final response information to the terminal.
The server packages the approved response text and associated metadata, such as message type and display options, into a response message and sends this message to the terminal over the network.
The input is the approved response text and metadata, and the output is a network response that reaches the terminal. The server may compress or encode the text to reduce bandwidth, then write the response to the network socket connected to the terminal.

### Step 16

The terminal presents the response information to the user.
The terminal receives the response message, extracts the response text, and displays it on a user interface, such as a chat window. When voice output is enabled, the terminal sends the text to a text-to-speech engine, receives a synthesized audio waveform, and plays the waveform through the speaker.
The input is the response message from the server, and the output is visual text on the display and/or audible speech from the speaker. The terminal performs UI rendering, calls the text-to-speech module with the response text, and controls the audio output device to reproduce the generated voice.

### Step 17

The user perceives the system's response and optionally continues interaction.
The user reads or listens to the encouragement or advice provided by the terminal and may decide to enter additional utterances or terminate the session.

1The input is the visual or audio feedback produced by the terminal, and the output is a new user action, such as another spoken utterance or a text reply, which forms a new input to Step 1. The user's behavior can change over time due to the system's support, and subsequent system processing uses the updated emotional context already stored on the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

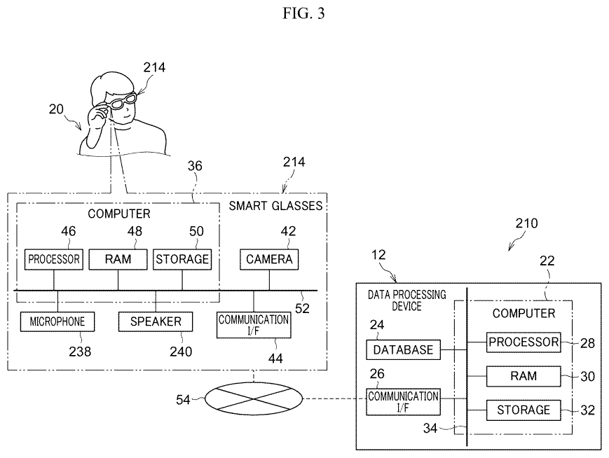

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

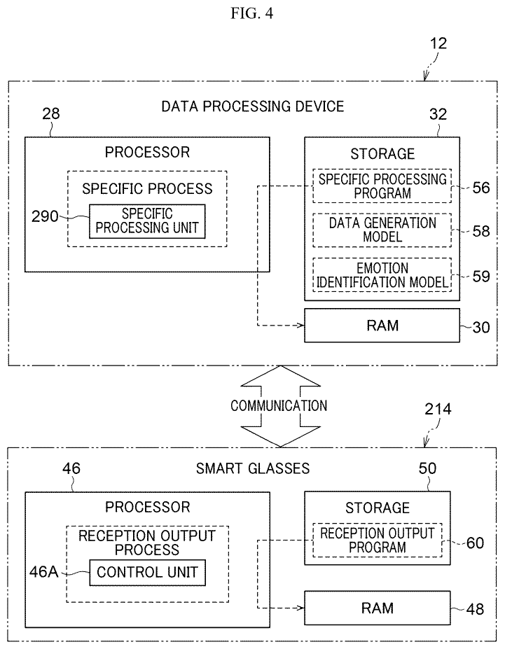

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

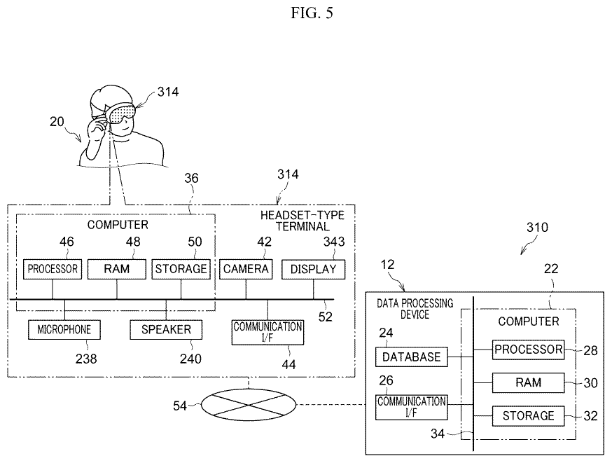

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

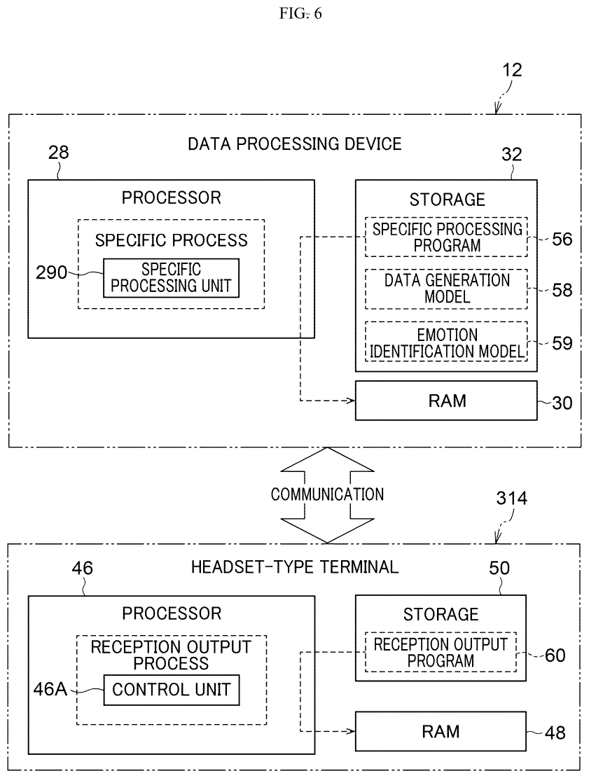

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

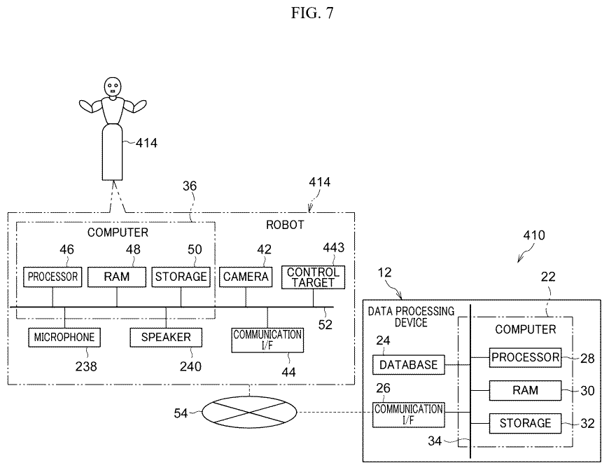

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

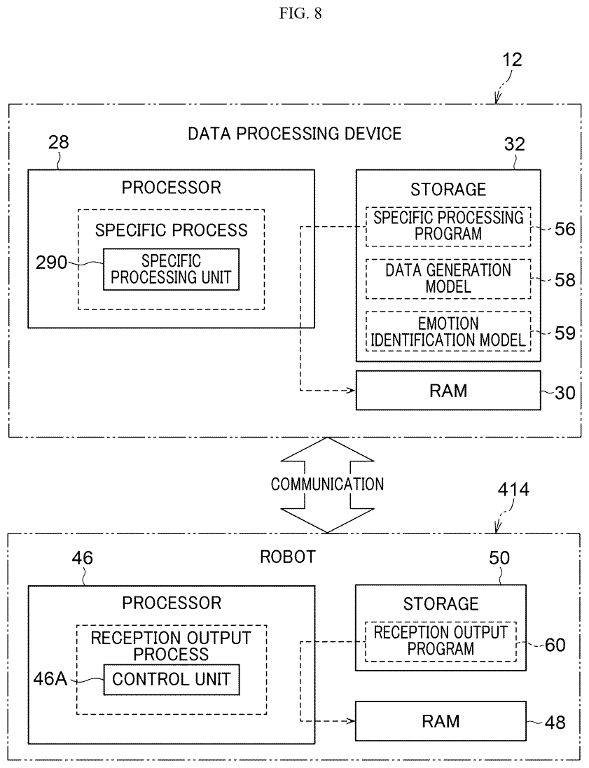

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

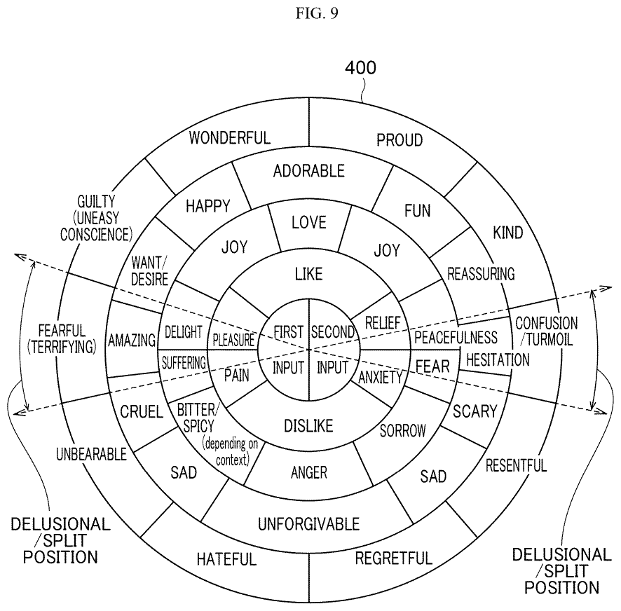

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

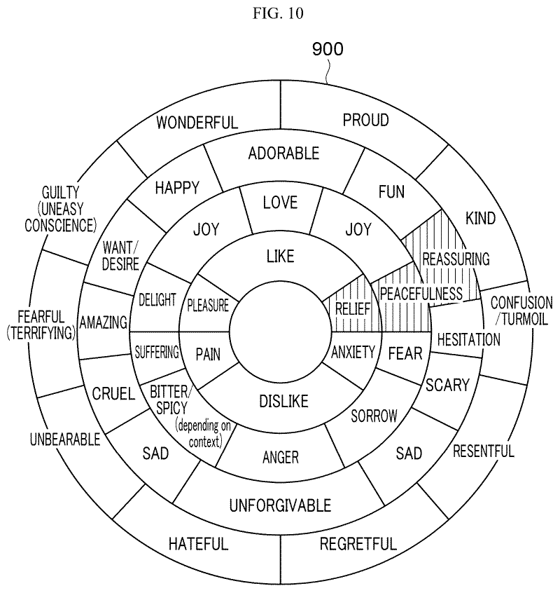

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire an utterance of a user via an input device and receive, from a terminal, digital information corresponding to the utterance,
generate, by using a natural language processing technique, an analysis result including emotion information, intent information, and key phrase information for text information corresponding to the utterance,
generate, on the basis of the analysis result and in accordance with stored template information, a prompt sentence reflecting an emotional state and an intent of the user, and configure the prompt sentence as a prompt for input to a generative AI model,
input the prompt sentence to the generative AI model and cause the generative AI model, by inference processing, to generate a response sentence including encouragement or advice for the user,
perform filtering processing on the response sentence to determine at least one of safety and appropriateness of content of the response sentence, and modify the response sentence or control output permission of the response sentence on the basis of a result of the filtering processing, and
transmit the response sentence to the terminal so that the terminal presents the response sentence to the user as at least one of display output via a display device and audio output via a speech synthesis device.

### Supplementary 2

The system according to supplementary 1,
wherein the processor is configured to
perform emotion classification processing and intent classification processing on the analysis result generated by the natural language processing technique to classify the emotional state and the intent of the user, select at least a part of the template information on the basis of classification results, and adjust at least one of style, length, and level of detail of content of the prompt sentence so as to dynamically optimize the prompt input to the generative AI model in accordance with the emotional state of the user.

### Supplementary 3

The system according to supplementary 1,
wherein the processor is configured to
cause the terminal, on the basis of the response sentence received from the system, to select at least one of text display via the display device and audio output via the speech synthesis device in accordance with at least one of operation information of the user and setting information of the terminal, and to present the response sentence to the user in accordance with a result of the selection.

### Application Example 1

### Supplementary 1

A system comprising a processor,
wherein the processor is configured to
acquire, via an audio input device mounted on a mobile information terminal, a user utterance as an acoustic signal, and transmit the acoustic signal to a server apparatus through a communication network,
convert, in the server apparatus, the acoustic signal into character string data by using a speech recognition program, execute natural language processing including morphological analysis, syntactic analysis, emotion estimation, and intent estimation on the character string data, and generate analysis result data representing a need and an emotional state of the user, construct, on the basis of the analysis result data and the character string data, a prompt sentence to be input to a generative language model, supply the prompt sentence to the generative language model to cause the generative language model to generate encouragement or advice, and format a response sentence acquired from the generative language model as output data representing the encouragement or the advice, and transmit the output data to the mobile information terminal and cause a display device provided in the mobile information terminal to display the encouragement or the advice as visual information.

### Supplementary 2

The system according to supplementary 1,
wherein the processor is configured to adjust a style, a length, and content constraints of the prompt sentence on the basis of the analysis result data representing the emotional state obtained by the natural language processing, and generate the prompt sentence that controls a tone and an amount of information of the encouragement or the advice in accordance with the emotional state of the user.

### Supplementary 3

The system according to supplementary 1,
wherein the processor is configured to store, in a storage device, dialogue history data in which attribute information representing the need and the emotional state of the user included in the analysis result data is associated with the response sentence acquired from the generative language model, and update at least one of components of the prompt sentence and parameters of the natural language processing on the basis of the dialogue history data to continuously improve generation performance of the encouragement or the advice suitable for customer service support in a physical store.

### Example 2

### Supplementary 1

A system comprising a processor,
wherein the processor is configured to
receive a user utterance as an audio signal via an input device of a terminal, convert the audio signal into digital audio information, and transmit the digital audio information to a server via a communication device of the terminal,
convert, at the server, the digital audio information into character information by executing a speech recognition process, execute natural language processing on the character information to estimate an emotional state of the user, and generate a prompt sentence for input to a generative information processing model based on the emotional state and the character information,
input the prompt sentence to the generative information processing model so as to cause generation of response information including encouragement or advice corresponding to the emotional state, and transmit the response information from the server to the terminal via the communication device, and
cause, at the terminal, the response information to be presented to the user via a display device or a voice output device.

### Supplementary 2

The system according to supplementary 1,
wherein the processor is configured to
calculate, at the server, an emotion category and a confidence degree from the character information by the natural language processing, generate structured information including the emotion category and the confidence degree, and determine an expression format or instruction content of the prompt sentence based on the structured information.

### Supplementary 3

The system according to supplementary 1,
wherein the processor is configured to
adjust at least one of a writing style, a response length, a degree of concreteness, and a topic range of the prompt sentence, based on the emotional state of the user, a past interaction history of the user, and past response information generated by the generative information processing model, so as to optimize content of the encouragement or the advice.

### Application Example 2

### Supplementary 1

A system comprising a processor,
wherein the processor is configured to
acquire user voice information or character information via an input device, convert acquired voice information into character information by using a speech recognition technique, analyze the character information by using a natural language processing technique, and estimate a user emotional state,
generate, on the basis of the estimated emotional state and the character information, a prompt sentence that is an instruction sentence to be input to a generative AI model, input the generated prompt sentence to the generative AI model and cause the generative AI model to generate response information including encouragement or advice corresponding to the emotional state,
provide the generated response information to the user as voice information or character information via an output device,
record the estimated emotional state in time series, compare a past emotional state with a current emotional state to identify a change in emotion, and dynamically change contents of the prompt sentence in accordance with the change in emotion, and
when the identified emotional state or the change in emotion is determined to be an abnormal state exceeding a predetermined criterion, transmit warning information to a monitoring information processing device.

### Supplementary 2

The system according to supplementary 1,
wherein the processor is configured to
store the estimated emotional state and the change in emotion as structured data including an emotion type, an intensity, and an occurrence time, calculate a stress tendency or an anxiety tendency of the user on the basis of the structured data, and adjust an expression format, a writing style, and a level of detail of contents of the prompt sentence to be input to the generative AI model in accordance with the calculated tendency.

### Supplementary 3

The system according to supplementary 1,
wherein the processor is configured to
when the emotional state estimated from user utterance in a monitoring target area exceeds a predetermined threshold with respect to at least one of tension, anger, anxiety, and fear, transmit, in real time, warning information including identification information regarding the user and a summary of the emotional state to the monitoring information processing device, and, in parallel with transmission of the warning information, present to the user the response information including encouragement or advice for providing a sense of security, the response information being generated by the generative AI model.

What is claimed is:

1. A system comprising:
circuitry configured to:
acquire, from a terminal device via a packet-switched network, input data corresponding to a user utterance;
analyze the input data by using a natural language processing technique to generate an analysis result including emotion information, intent information, and key phrase information;
generate, based on the analysis result and in accordance with stored template information, a prompt sentence reflecting an estimated emotional state and an intent derived from the analysis result, and configure the prompt sentence as an input to a generative neural network model;
input the prompt sentence to the generative neural network model and cause the generative neural network model to generate, by inference processing, response data based on the prompt sentence;
perform filtering processing on the response data to determine at least one of safety or appropriateness of content of the response data, and modify the response data or control output permission of the response data based on a result of the filtering processing; and
transmit the response data to the terminal device via the packet-switched network so as to cause the terminal device to present the response data to a user.

2. The system according to claim 1, wherein the circuitry is configured to perform emotion classification processing and intent classification processing on the analysis result to classify the emotional state and the intent, select at least a part of the template information based on classification results, and adjust at least one of style, length, or level of detail of the prompt sentence so as to dynamically optimize the input to the generative neural network model in accordance with the classified emotional state.

3. The system according to claim 2, wherein the circuitry is configured to calculate an emotion category and a confidence degree from the input data by the natural language processing technique, generate structured information including the emotion category and the confidence degree, and determine an expression format or instruction content of the prompt sentence based on the structured information.

4. The system according to claim 3, wherein the circuitry is configured to adjust at least one of a writing style, a response length, a degree of concreteness, or a topic range of the prompt sentence, based on the emotional state, a past interaction history stored in a storage device, and past response data generated by the generative neural network model.

5. The system according to claim 4, wherein the circuitry is configured to store dialogue history data in the storage device in which attribute information representing the intent and the emotional state is associated with the response data, and update at least one of components of the prompt sentence or parameters of the natural language processing technique based on the dialogue history data.

6. The system according to claim 5, wherein the circuitry is configured to record the estimated emotional state in time series, compare a past emotional state with a current emotional state to identify a change in emotion, and dynamically change contents of the prompt sentence in accordance with the identified change.

7. The system according to claim 1, wherein the circuitry is configured to convert an audio signal received from the terminal device into character string data by executing a speech recognition process, and execute the natural language processing technique on the character string data including morphological analysis, syntactic analysis, and semantic analysis.

8. The system according to claim 7, wherein the circuitry is configured to perform tokenization, part-of-speech tagging, and dependency parsing on the character string data, and extract the key phrase information by identifying noun phrases and verb phrases having a relevance score exceeding a predetermined threshold.

9. The system according to claim 8, wherein the generative neural network model comprises a transformer architecture including an embedding layer, a plurality of self-attention layers, and an output layer configured to produce a probability distribution over a token vocabulary.

10. The system according to claim 9, wherein the circuitry is configured to set inference parameters for the generative neural network model including a temperature value, a sampling threshold, and a maximum output token count so as to control tone and length of the response data.

11. The system according to claim 1, wherein the filtering processing includes applying a content classification model to the response data to detect at least one of harmful content, inappropriate language, or factual inconsistency, and replacing or suppressing portions of the response data that are determined to be outside a predetermined safety criterion.

12. The system according to claim 11, wherein the circuitry is configured to compute a safety score for the response data and compare the safety score against a threshold, and when the safety score is below the threshold, regenerate the response data by modifying the prompt sentence and re-inputting the modified prompt sentence to the generative neural network model.

13. The system according to claim 12, wherein the circuitry is configured to log the filtering results and the safety score in the storage device for subsequent analysis and model refinement.

14. The system according to claim 1, wherein the circuitry is configured to cause the terminal device, based on the response data, to select at least one of text display via a display device or audio output via a speech synthesis device in accordance with at least one of operation information or setting information received from the terminal device.

15. The system according to claim 14, wherein the circuitry is configured to convert the response data into audio data by using a speech synthesis function, controlling at least one of a speaker attribute, a speaking rate, or a prosody parameter.

16. The system according to claim 1, wherein the circuitry is configured to store the estimated emotional state as structured data including an emotion type, an intensity, and an occurrence time in the storage device, compute a tendency value based on the structured data over a predetermined time period, and adjust the prompt sentence in accordance with the computed tendency value.

17. The system according to claim 16, wherein the circuitry is configured to, when the estimated emotional state or a change in the emotional state exceeds a predetermined criterion, transmit notification data to a monitoring device via the packet-switched network.

18. A system comprising:
circuitry configured to:
acquire, from a terminal device via a packet-switched network, input data corresponding to a user utterance, and convert the input data into character string data by executing a speech recognition process;
execute natural language processing on the character string data including morphological analysis, syntactic analysis, emotion estimation, and intent estimation, and generate analysis result data representing an emotional state and an intent of the user;
construct, based on the analysis result data and the character string data, a prompt sentence for input to a generative neural network model comprising a transformer architecture with self-attention layers, the prompt sentence reflecting the emotional state and the intent;
input the prompt sentence to the generative neural network model to cause the generative neural network model to generate response data, and perform filtering processing on the response data to determine safety and appropriateness of content; and
transmit the response data to the terminal device via the packet-switched network so as to cause the terminal device to present the response data via at least one of a display device or a speech synthesis device.

19. The system according to claim 18, wherein the circuitry is configured to record the emotional state in time series in a storage device, compare a past emotional state with a current emotional state to identify a change, and dynamically adjust contents of the prompt sentence in accordance with the identified change.

20. A method comprising:
acquiring, by circuitry from a terminal device via a packet-switched network, input data corresponding to a user utterance;
analyzing the input data by using a natural language processing technique to generate an analysis result including emotion information, intent information, and key phrase information;
generating, based on the analysis result and in accordance with stored template information, a prompt sentence reflecting an estimated emotional state and an intent derived from the analysis result, and configuring the prompt sentence as an input to a generative neural network model;
inputting the prompt sentence to the generative neural network model and causing the generative neural network model to generate, by inference processing, response data based on the prompt sentence;
performing filtering processing on the response data to determine at least one of safety or appropriateness of content of the response data, and modifying the response data or controlling output permission of the response data based on a result of the filtering processing; and
transmitting the response data to the terminal device via the packet-switched network so as to cause the terminal device to present the response data to a user.
